(19) United States
(12) Patent Application Publication
(10) Pub. No.: US 2023/0141058 A1
(43) Pub. Date: May 11, 2023

(54) DISPLAY APPARATUS AND METHOD FOR CONTROLLING DISPLAY APPARATUS

(71) Applicant: SHARP KABUSHIKI KAISHA, Sakai City (JP)

(72) Inventor: Kenji OGASAWARA, Sakai City (JP)

(21) Appl. No.: 17/983,229

(22) Filed: Nov. 8, 2022

(30) Foreign Application Priority Data
Nov. 9, 2021 (JP) 2021-182620

(51) Int. Cl. G06F 3/04883

(52) U.S. Cl. CPC G06F 3/04883; G06F 2203/04804

(57) ABSTRACT

A display apparatus includes a display and a controller. The controller displays, on the display, a first display screen including a transparent region and a second display screen displayed behind the first display screen in a superimposed manner, and processes an operation on the transparent region as an operation on the second display screen and processes an operation on a region other than the transparent region as an operation on the first display screen.

### BACKGROUND OF THE INVENTION

### Field of the Invention

The present disclosure relates to a display apparatus and the like.

### Description of the Background Art

In general, various devices include a display that displays information, and technologies have been used to improve usability.

For example, an information processing apparatus is known, which includes a display that displays a transparent front view screen and a rear view screen behind the front view screen in a superimposed manner, a front touch panel that accepts operations on the front view screen, and a rear touch pad that accepts operations on the rear view screen and is provided. independently of the front touch panel.

A UI (User Interface), such as an operation screen, of an information processing apparatus used by a plurality of users in an office, such as a digital multifunction peripheral (image-forming apparatus), often has a single screen configuration because functions of the information processing apparatus are limited and a size of a screen of the information processing apparatus is relatively small. Specifically, the information processing apparatus does not output multiplexed screen through a window system unlike a personal computer. Even when a window system is employed, one window is displayed in a full screen. In recent years, network access is indispensable for image-forming apparatuses and like apparatuses, and therefore, a web browser may be incorporated in such an apparatus and a UI may be implemented on the web browser. Web browsers can manage and display a plurality of contents. Therefore, even with a single screen configuration, such as a UI of an image-forming apparatus, content inside the apparatus (internal content) and external content (content acquired from an external apparatus, such as an external server) can be simultaneously displayed and operated, and accordingly, usability is improved.

Here, in a case of a single screen (full screen display in one window), the internal content and the external content are generally displayed in combination using HTML (Hyper Text Markup Language) iframe tags. However, due to security restrictions, such as cross-domain restrictions, the internal content and the external content may not be displayed in combination on a single screen (full-screen display in one window). Specifically, the web browser installed in the image-forming apparatus may not be able to display the internal content (a copy screen, a scan screen, etc. and a system region) and the external content (a cloud service on the Internet) in combination on a single screen when attempting to simultaneously manage and display the internal content and the external content. To address this problem, the internal content and the external content may be displayed in different windows. In this case, although it is desirable that operations similar to those for the single screen configuration may be performed, this issue has not been considered in the general technology.

The present disclosure is made in view of the foregoing problem and to provide a display apparatus or the like that can appropriately process operations when a plurality of screens are displayed in a superimposed manner.

### SUMMARY OF THE INVENTION

To solve the above-mentioned problems, a display apparatus according to the present disclosure includes a display and a controller, and the controller displays, on the display, a first display screen that includes a transparent region and a second display screen displayed behind the first display screen in a superimposed manner, and processes an operation on the transparent region as an operation on the second display screen and processes an operation on a region other than the transparent region as an operation on the first display screen.

A method for controlling a display apparatus includes displaying, on the display, a first display screen that includes a transparent region and a second display screen displayed behind the first display screen in a superimposed manner, and processing an operation on the transparent region as an operation on the second display screen and processing an operation on a region other than the transparent region as an operation on the first display screen.

According to the present disclosure, a display apparatus or the like capable of appropriately performing processes for operations when a plurality of screens are displayed in a superimposed manner can be provided.

### BRIEF DESCRIPTION OF THE DRAWINGS

FIG. 1 is an external perspective view of an image-forming apparatus according to a first embodiment.

FIG. 2 is a diagram illustrating a functional configuration of the image-forming apparatus according to the first embodiment.

FIG. 3 is a diagram illustrating an example of a data structure of screen setting information according to the first embodiment.

FIGS. 4A to 4C are diagrams illustrating an overview of a process according to the first embodiment.

FIG. 5 is a diagram illustrating an overview of a process according to the first embodiment.

FIG. 6 is a diagram illustrating an overview of a process according to the first embodiment.

FIG. 7 is a flowchart of a flow of a main process of the image-forming apparatus according to the first embodiment.

FIG. 8 is a flowchart of a flow of a process executed by a browser controller according to the first embodiment.

FIG. 9 is a flowchart of a flow of a process executed by a display controller according to the first embodiment.

FIG. 10 is a flowchart of a flow of a process executed by an internal window engine according to the first embodiment.

FIGS. 11A to 11C are diagrams illustrating an operation example according to the first embodiment.

FIGS. 12A to 12C are diagrams illustrating an operation example according to the first embodiment.

FIGS. 13A to 13C are diagrams illustrating an operation example according to the first embodiment.

FIG. 14 is a diagram illustrating an overview of a process according to a second embodiment.

FIG. 15 is a flowchart of a flow of a process executed by an external window engine according to the second embodiment.

FIG. 16 is a flowchart of a flow of a process executed by the external window engine according to the second embodiment.

FIG. 17 is a flowchart of a flow of a process executed by a display controller according to the second embodiment.

FIG. 18 is a flowchart of a flow of a process executed by a browser controller according to the second embodiment.

FIG. 19 is a flowchart of a flow of a process executed by an internal window engine according to the second embodiment.

FIGS. 20A and 20B are diagrams illustrating an operation example according to the second embodiment.

FIG. 21 is a diagram illustrating a functional configuration of an image-forming apparatus according to a third embodiment.

FIG. 22 is a diagram n illustrating an example of a data structure of touch information according to the third embodiment.

FIG. 23 is a flowchart of a flow of a process executed by an internal window engine according to the third embodiment.

FIGS. 24A to 24D are diagrams illustrating an operation example according to the third embodiment.

FIGS. 25A to 25C are diagrams illustrating an operation example according to the third embodiment.

FIG. 26 is a diagram illustrating a functional configuration of an image-forming apparatus according to a fourth embodiment.

FIG. 27 is a flowchart of a flow of a process executed by an internal window engine according to the fourth embodiment.

FIG. 28 is a flowchart of a flow of a touch information update process according to the fourth embodiment.

FIGS. 29A to 29C are diagrams illustrating an operation example according to the fourth embodiment.

FIGS. 30A to 30C are diagrams illustrating an operation example according to the fourth embodiment.

### DESCRIPTION OF THE PREFERRED EMBODIMENTS

Hereinafter, embodiments of the present disclosure will be described with reference to the accompanying drawings. Note that the embodiments below are merely examples for describing the present disclosure, and the technical scope of the disclosure set forth in the claims is not limited to the description below.

### 1. First Embodiment

### 1.1 Functional Configuration

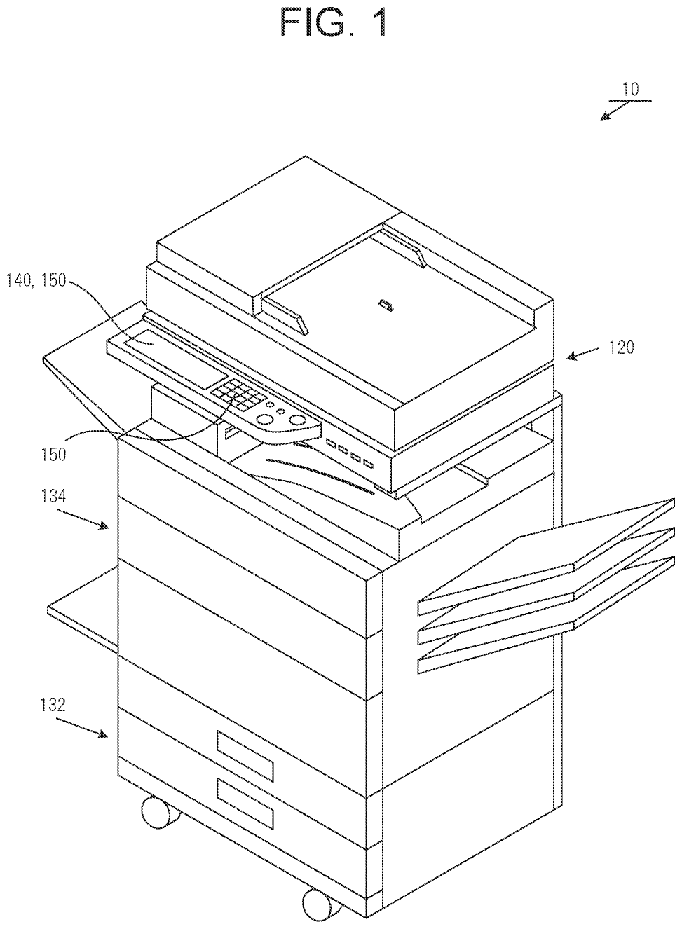

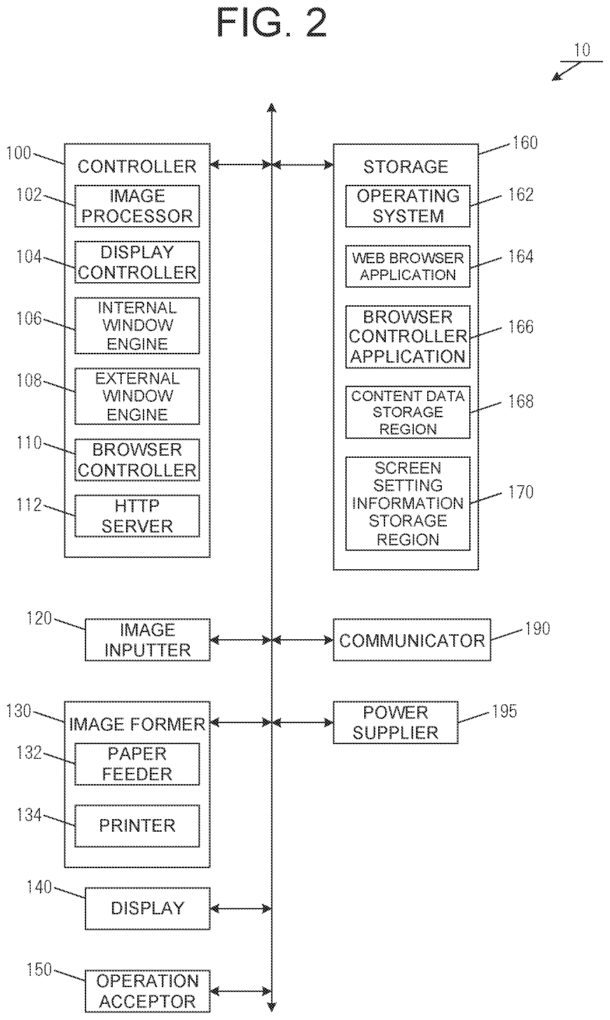

A first embodiment will be described with reference to the drawings. FIG. 1 is an external perspective view of an image-forming apparatus 10 according to a first embodiment, and FIG. 2 is a block diagram illustrating a functional configuration of the image-forming apparatus 10.

The image-forming apparatus 10 is an information processing apparatus having a copy function, a scan function, a document printing function, a facsimile function, and the like and is also referred to as an MFP (Multi-Function Printer/Peripheral). As illustrated in FIG. 2, the image-forming apparatus 10 includes a controller 100, an image inputter 120, an image former 130, a display 140, an operation acceptor 150, a storage 160, a communicator 190, and a power supplier 195 that supplies electric power to the functional portions in the image-forming apparatus 10.

The controller 100 is a functional portion for controlling the entire image-forming apparatus 10. The controller 100 reads and executes various programs stored in the storage 160 to implement various functions, and includes, for example, one or more computing devices (a CPU (Central Processing Unit)) and the like. Furthermore, the controller 100 may also be configured as an SoC (System on a Chip) having a plurality of functions among those described below.

The controller 100 executes the programs stored in the storage 160 to function as an image processor 102, a display controller 104, an internal window engine 106, an external window engine 108, a browser controller 110, and an HTTP (Hyper Text Transfer Protocol) server 112. Here, the display controller 104, the internal window engine 106, and the external window engine 108 are realized when a web browser application 164 described below is executed. Furthermore, the browser controller 110 is realized when a browser controller application 166 described below is executed.

The image processor 102 performs various processes relating to images. For example, the image processor 102 executes a sharpening process and a tone conversion process on an image input by the image inputter 120.

The display controller 104 displays two windows on the display 140, that is, an internal content window serving as a first display screen (hereinafter referred to as an “internal window”) and an external content window serving as a second display screen (hereinafter referred to as an “external window”). Furthermore, the display controller 104 causes the internal and external windows to process operations entered by a user on the internal and external windows.

The internal and external windows render screens based on a process of a web browser display engine (an HTML (Hyper Text Markup Language) rendering engine).

The external window displays content (e.g., a cloud service) that is managed by an external apparatus and that is on the Internet or other networks. The internal window (a display region) displays content (internal content) managed and stored inside the image-forming apparatus 10 and can be made transparent in a predetermined region. The internal window can display content of the external window on the display 140 by displaying the external content in a transparent region.

The display controller 104 displays the two windows, that is, the internal window and the external window, in a superimposed manner on the display 140. The display controller 104 displays the internal window on a near side relative to (in front of) the external window and over an entire display region of the display 140. The display controller 104 displays the external window at a back (a rear) of the internal window in a superimposed manner. The front-back relationship (Z-order) between the internal and external windows is fixed and the internal window displayed at the front is not interchangeable with the external window displayed at the back.

The display controller 104 makes a portion of the internal window transparent depending on a screen (content) to be displayed. The region that is transparent is referred to as a transparent region in this embodiment. When the internal window includes a transparent region, a screen with content of the external window is displayed in the transparent region on the display 140.

In this embodiment, the internal content includes a system region at a top. The system region includes content, such as information on the image-forming apparatus 10 and buttons for switching functions to be used arranged therein, and positions and ranges (heights, etc.) are predefined. The display controller 104 displays the system region regardless of whether the internal window includes a transparent region. On the other hand, external content does not include the system region. The external window is smaller in a vertical (Y-axis) size than the internal window because the external window does not display the system region.

The internal window engine 106 displays a screen (content) generated by interpreting HTML in the internal window and executes JavaScript (registered trademark) programs called from the content. Specifically, the internal window engine 106 is for the internal window (an HTML rendering engine). Furthermore, the external window engine 108 is for the external window (an HTML rendering engine).

Note that, in this embodiment, a portion (an engine) that interprets HTML to generate a screen is also referred to as a browser engine layer. Although the browser engine layer is divided into two portions, that is, the internal window engine 106 for the internal window and the external window engine 108 for the external window in this embodiment, the browser engine layer may be a common engine for both the internal and external windows.

The display controller 104, the internal window engine 106, and the external window engine 108 described above realize a web browser of this embodiment. Processes executed by the display controller 104, the internal window engine 106, and the external window engine 108 will be described below.

The browser controller 110 controls the web browser by performing processes such as a process of notifying the web browser of content of an operation. Note that the browser controller 110 is capable of performing HTTP communication (communication via WebSocket) and performs a prescribed communication with the internal window engine 106. The processes performed by the browser controller 110 will be described below. Note that, in this embodiment, the term “notification” includes transmission and reception of predetermined information. In this case, a notifier transmits information to a notified party and the notified party receives the information.

The HTTP server 112 transmits HTML (Hyper Text Markup Language) data, CSS (Cascading Style Sheets) data, and image data based on the HTTP protocol. When receiving an HTTP request, the HTTP server 112 transmits requested data to a transmission source of the HTTP request (a client).

The image inputter 120 inputs image data to the image-forming apparatus 10. For example, the image inputter 120 includes a scan device or the like capable of reading an image to generate image data. The scan device converts an image into an electric signal using an image sensor, such as a CCD (Charge Coupled Device) or a CIS (Contact Image Sensor), and quantizes and encodes the electric signal thereby to generate digital data.

The image former 130 forms (prints) an image on a recording medium, such as a recording sheet. The image former 130 is composed of, for example, a laser printer using an electrophotographic method. The image former 130 includes a paper feeder 132 and a printer 134. The paper feeder 132 feeds recording sheets. The paper feeder 132 includes a paper feeding tray and a manual feed tray. The printer 134 forms (prints) an image on a surface of a recording sheet, and discharges the recording sheet from a sheet discharge tray.

The display 140 displays various information. The display 140 is configured by a display device, such as an LCD (Liquid Crystal Display), an organic EL (electro-luminescence) display, or a micro LED display.

The operation acceptor 150 accepts an operation of the user of the image-forming apparatus 10. The operation acceptor 150 is composed of an input device, such as a touch sensor. A method for detecting an input on the touch sensor may be any general detection method, such as a resistive method, an infrared method, an inductive method, or a capacitive method. Furthermore, the image-forming apparatus 10 may include a touch panel formed by integrating the display 140 and the operation acceptor 150.

The storage 160 stores various programs and various data required for operation of the image-forming apparatus 10. The storage 160 is composed of, for example, a storage device, such as an SSD (Solid State Drive) which is a semiconductor memory or an HDD (Hard Disk Drive).

The storage 160 stores an operating system 162, the web browser application 164, and the browser controller application 166. The storage 160 further ensures a content data storage region 168 and a screen setting information storage region 170 as storage regions.

The operating system 162 is underlying software for operating the image-forming apparatus 10. The operating system 162 is read and executed by the controller 100 to execute a program, detect an operation input via the operation acceptor 150, and transmit information (event information) on the detected operation to the program. The operating system 162 may provide a platform for executing a program and for transmitting and receiving event information.

The web browser application 164 is a program for causing the controller 100 to realize functions of the display controller 104, the internal window engine 106, and the external window engine 108. The browser controller application 166 is a program that causes the controller 100 to perform the functions of the browser controller 110.

The content data storage region 168 stores content data used to display a screen (content inside the image-forming apparatus 10) in the internal window. Examples of the content data include HTML data, CSS data, and image data.

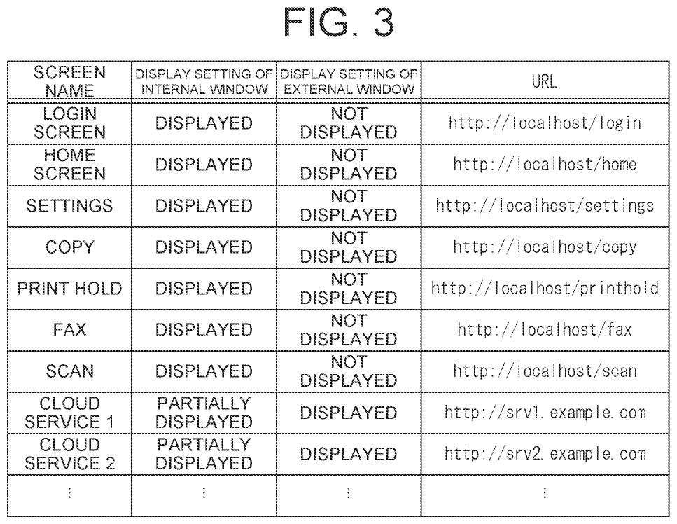

The screen setting information storage region 170 stores information on settings of a screen to be displayed on the display 140 (screen setting information). The screen setting information includes, for example, as shown in FIG. 3, a screen name that identifies a screen (e.g., “login screen”), a display setting for the internal window (e.g., “Displayed”), a display setting for the external window (e.g., “Not Displayed”), and a URL (Uniform Resource Locator, such as “http://localhost/login”) indicating a source of obtaining of content.

As a display setting of the internal window, “Displayed” or “Partially Displayed” is stored. “Displayed” indicates that the internal window which does not include any transparent region is displayed. “Partially Displayed” indicates that the internal window which includes a transparent region is displayed. The transparent region in this embodiment displays the external content, and is defined as a region other than the system region in the internal content.

As a display setting of the external window, “Displayed” indicating that the external window is to be displayed or “Not Displayed” indicating that the external window is not to be displayed is stored. In the case of “Not Displayed”, the external window may employ a display method for displaying a blank page (about:blank) and waiting.

The communicator 190 communicates with external devices via a LAN (Local Area Network) or a WAN (Wide Area Network). The communicator 190 includes, for example, a communication device, such as NIC (Network Interface Card) used in a wired/wireless LAN, and a communication module. Furthermore, the communicator 190 may also communicate with other devices via a telephone line. In this case, the communicator 190 is configured by an interface (a terminal) into which a cable to be connected to the telephone line can be inserted, and performs image transmission and reception to and from another device by performing facsimile communication using of a general standard, such as a G3/G4 standard, and a general protocol.

### 2 Outline of Processing

### 1.2.1 Internal and External Windows

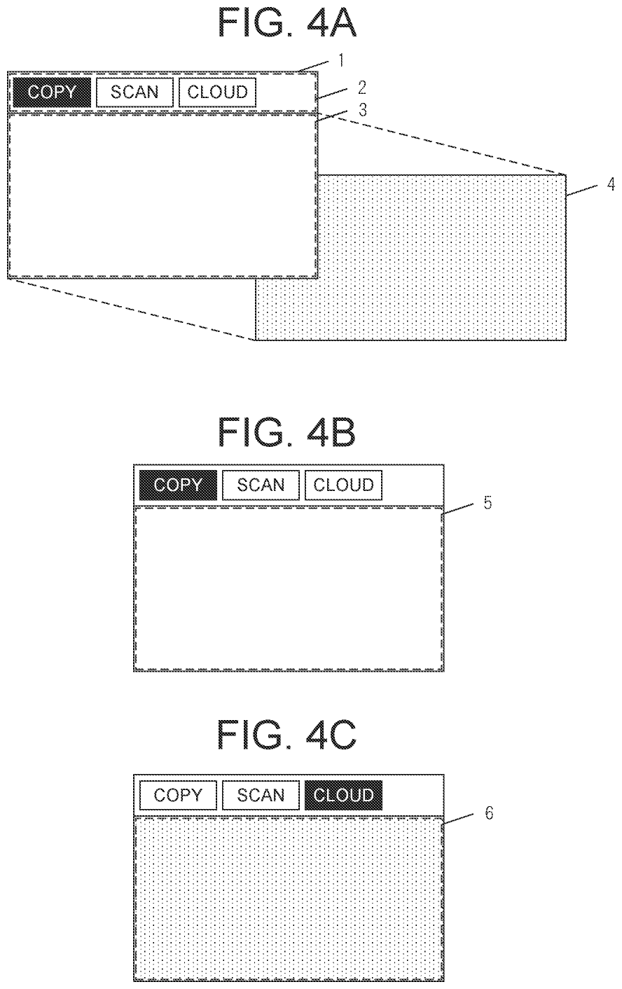

The relationship between the internal and external windows will be described with reference to FIGS. 4A to 4C. In FIG. 4A, 1 indicates the internal window. The internal window includes a region for displaying the system region (2 in FIG. 4A) and a region for displaying content outside the system region (3 in FIG. 4A, that is, a “content display region”, hereinafter).

In FIG. 4A, 4 indicates the external window. A size of the external window is the same as that of the content display region. Furthermore, a position of the external window is the same as that of the content display region. Since the internal window (1 in FIG. 4A) is displayed in front of the external window (4 in FIG. 4A), the external window is hidden by the content display region of the internal window.

FIG. 4B is a diagram illustrating a display example when the internal content (e.g., an operation screen for the copy function and an operation screen for the scan function) is displayed. The content used to set the copy and scan functions and to execute jobs are displayed in the content display region of the internal window (5 in FIG. 4B).

FIG. 4C is a diagram illustrating an example of display when external content is displayed. In this case, the content display region of the internal window (6 in FIG. 4C) is a transparent region, and display content of the external window (the external content) located behind the content display region of the internal window is displayed. As a result, the display 140 displays the content in the system region and the external content.

### 1.2.2 Screen Transition

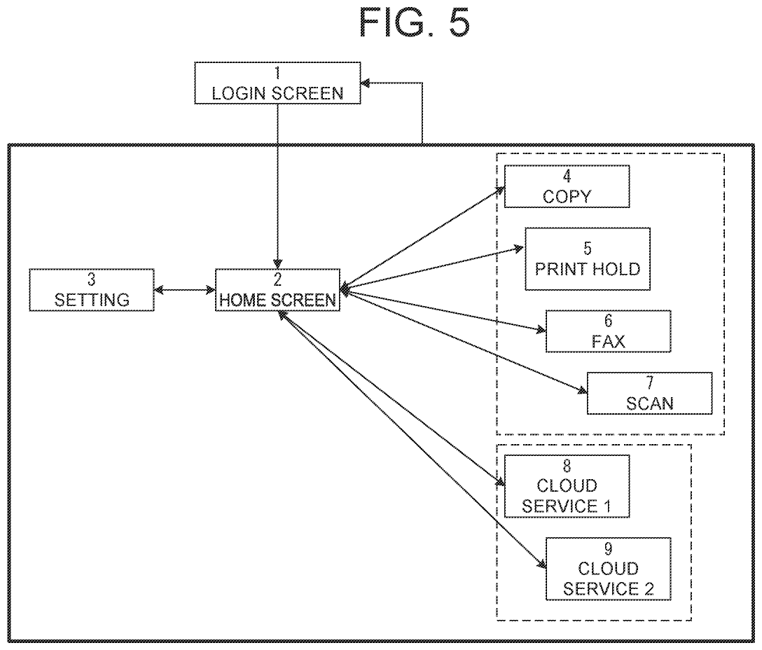

FIG. 5 is a diagram illustrating an example of transition from each screen to the next. When power is on, the image-forming apparatus 10 displays a login screen (1 of FIG. 5) to authenticate a user. After the user authentication, the image-forming apparatus 10 displays a home screen (2 in FIG. 5). The home screen causes the user to select a function (a job) to be realized by the image-forming apparatus 10.

Based on a user operation, the image-forming apparatus 10 displays the setting screen (3 in FIG. 5) and operation screens for various functions using the home screen. Examples of the operation screens include an operation screen for the copy function (4 in FIG. 5), an operation screen for the print hold function (5 in FIG. 5), an operation screen for the facsimile function (6 in FIG. 5), and an operation screen for the scan function (7 in FIG. 5). These screens are operation screens for the functions (native functions) of the image-forming apparatus 10, and are the internal content. On the other hand, a cloud service 1 (88 in FIG. 5) and a cloud service 2 (9 in FIG. 5) are screens that display external content provided by an external apparatus. The cloud services can be registered the setting screen. Each of the screens shown in FIG. 5 is displayed based on screen setting information stored in the screen setting information storage region 170.

### 1.2.3 Flow of Operation Information

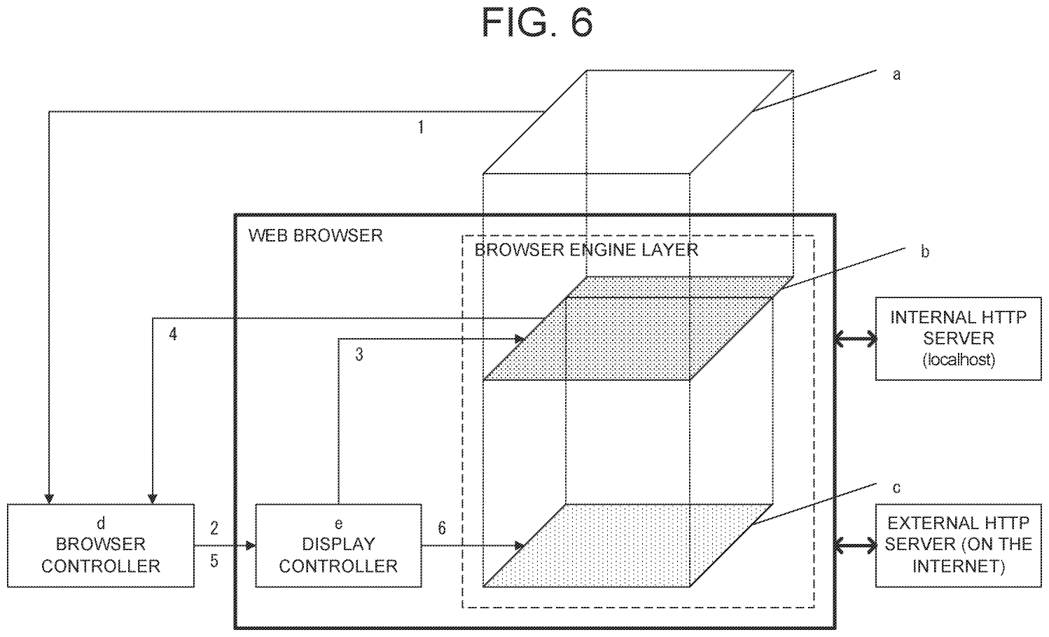

FIG. 6 is a diagram illustrating a notification route of operation information (an event) when an operation, such as touch operation, is performed. In FIG. 6, a indicates an operating system (hereinafter referred to as an “OS”), b indicates the internal window, c indicates the external window, d indicates the browser controller 110, and e indicates the display controller 104. Note that the screens (content) displayed in the external and internal windows are generated by the internal window engine 106 and the external window engine 108 that constitute a browser engine layer. Furthermore, it is assumed that an event of a notification target is a touch event associated with a touch operation in a description below.

First, the OS notifies the browser controller 110 of a touch event (1 in FIG. 6). The browser controller 110 notifies the web browser of the notified touch event as a touch event for the internal window using inter-process communication (2 in FIG. 6). The display controller 104 of the web browser processes the notified touch event as an event for the internal window (3 in FIG. 6). In this case, when the internal window is displaying external content, the internal window determines whether the notified touch event is an operation on a displayed portion of the external content (a transparent region of the internal window).

When it is determined that the notified touch event is a touch event for the external content, the internal window uses HTTP communication (WebSocket) to notify the browser controller 110 of the touch event (4 in FIG. 6). The browser controller 110 notifies the web browser of the notified touch event as a touch event for the external window using inter-process communication (5 in FIG. 6). The display controller 104 of the web browser processes the notified touch event as an event for the external window (6 in FIG. 6).

Note that, when the internal window does not determine that the operation is for the external content in 3 in FIG. 6, the process of 4 in FIG. 6 is not performed. As a result, the processes in 5 and 6 of FIG. 6 are not executed, and the touch event is simply processed as an event for the internal window.

Furthermore, the web browser is realized by the internal window (b in FIG. 6), the external window (c an FIG. 6), and the display controller 104 (e in FIG. 6). The web browser communicates with an internal HTTP server (the HTTP server 112) and an external HTTP server on the Internet that is an external server, to acquire content. Furthermore, the web browser displays the acquired content on the internal window or the external window through a process performed by the display controller 104.

### 1.3 Processing Flow

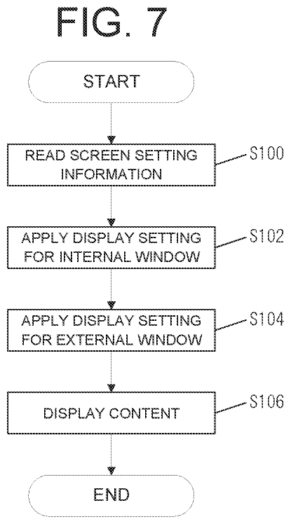

Next, referring to FIGS. 7 to 10, flows of processes executed by the image-forming apparatus 10 will be described. The processes shown in FIGS. 7 to 10 are executed when the controller 100 reads a program stored in the storage 160.

Here, the controller 100 reads and executes the operating system 162 to operate the OS. Accordingly, the controller 100 detects operations input by the user (e.g., a touch operation input via the operation acceptor 150). In addition, the controller 100 causes the display controller 104, the internal window engine 106, the external window engine 108, the browser controller 110, and the HTTP server 112 to function on the OS. When the OS operated by the controller 100 detects an operation input by the user, the OS notifies the browser controller 110 of the operation (an event), and in addition, of information indicating content of the operation.

### 1.3.1 Main Processing

A main process executed by the image-forming apparatus 10 of this embodiment will be described referring to FIG. 7. The process shown in FIG. 7 is executed when a screen displayed on the display 140 is updated.

First, the controller 100 reads the screen setting information for a screen to be displayed on the display 140 from the screen setting information storage region 170 based on a user operation or a state of the image-forming apparatus 10 (step S100).

Then, the controller 100 applies a display setting of the internal window included in the screen setting information read in step S100 to the internal window (step S102). Furthermore, the controller 100 applies a display setting of the external window included in the screen setting information read in step S100 to the external window (step S104).

Subsequently, the controller 100 displays content (step S106). For example, when a URL included in the screen setting information read in step S100 includes a domain name (such as “localhost”) of the HTTP server 112, the controller 100 displays content specified by the URL on the internal window. Furthermore, when the URL included in the screen setting information read in step S100 includes a domain name other than a domain name of the HTTP server 112, the controller 100 displays content specified by the URL on the external window.

### 1.3.2 Process of Browser Controller

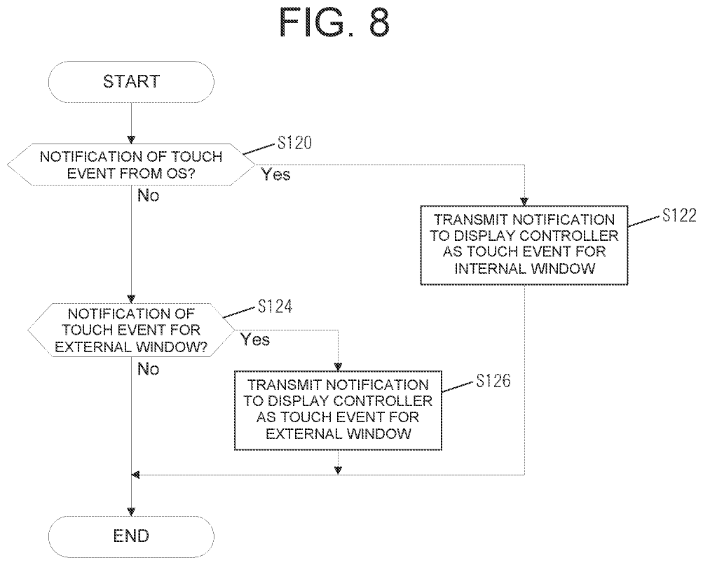

The process performed by the browser controller 110 will be described with reference to FIG. 8. Note that the browser controller 110 repeatedly performs a process illustrated in FIG. 8.

First, the browser controller 110 determines whether a touch event has been notified by the OS (step S120). The touch event is notified together with information indicating content of the operation (operation information), such as, a touched position and a state of the touch operation. Information on the state of the touch operation is associated with an action of the touch operation, such as a new setting of a touch position (start of a touch operation), a shift of a touch position, or removal of a touch position (termination of a touch operation).

When a touch operation has been notified by the OS, the browser controller 110 notifies the browser (the display controller 104) of the touch event as a touch event of the internal window through the inter-process communication (step S120; Yes→step S122).

On the other hand, when a touch event has not been notified by the OS, the browser controller 110 determines whether a touch event for the external window has been notified by the internal window (step S120; No→step S124). Note that, in this embodiment, the internal window engine 106 notifies the browser controller 110 of the touch event for the external window using HTTP communication (WebSocket). When a touch event for the external window has been notified, the browser controller 110 notifies the browser (the display controller 104) of the touch event for the external window through the inter-process communication (step S124; Yes→step S126). Accordingly, the browser controller 110 notifies the browser (the display controller 104) of the touch event notified in step S122, this time as a touch event for the external window. Note that, when a touch event for the external window has not been notified, the browser controller 110 omits the process in step S126 (step S124; No).

### 1.3.3 Display Controller

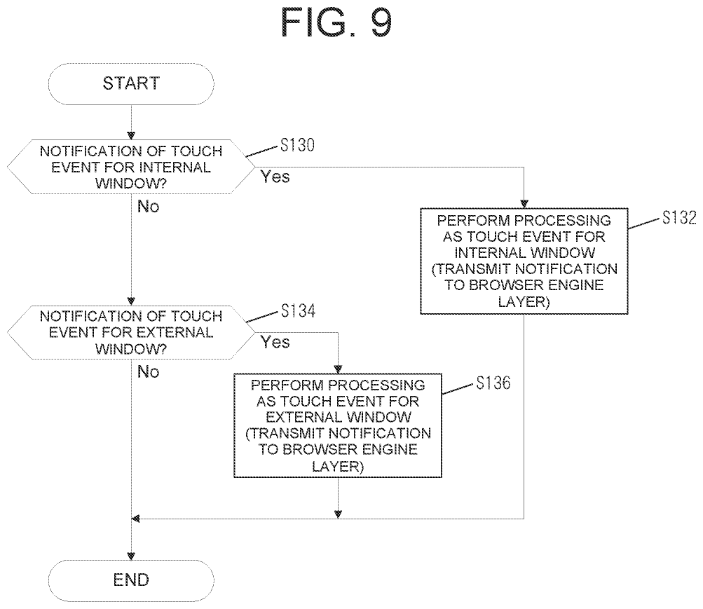

A process executed by the display controller 104 will be described with reference to FIG. 9. Note that the display controller 104 repeatedly performs a process illustrated in FIG. 9.

First, the display controller 104 determines whether a touch event for the internal window has been notified by the browser controller 110 (step S130). When a touch event for the internal window has been notified, the display controller 104 processes the touch event as a touch event for the internal window (step S130; Yes→step S132). For example, the display controller 104 notifies the internal window engine 106 (the browser engine layer) of the touch event.

On the other hand, a touch event for the internal window has not been notified, the display controller 104 determines whether a touch event for the external window has been notified by the browser controller 110 (step S130; No→step S134), When a touch event for the external window has been notified, the display controller 104 processes the touch event as a touch event for the external window (step S134; Yes→step S136). For example, the display controller 104 notifies the external window engine 108 (the browser engine layer) of the touch event. Note that, when a touch event for the external window has not been notified, the browser controller 110 omits the process in step S136 (step S134; No).

### 1.3.4 Internal Window Engine

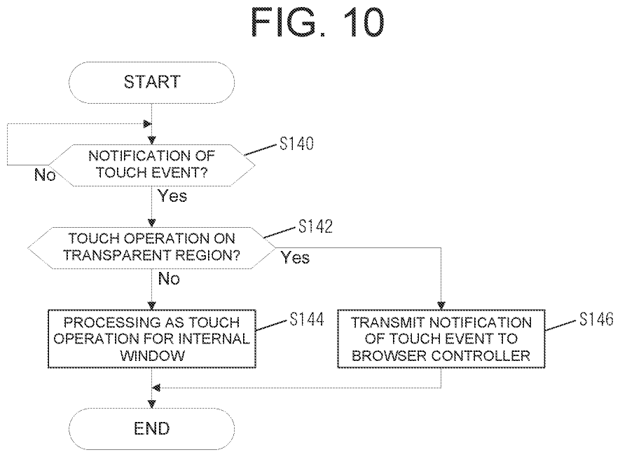

A process executed by the internal window engine 106 will be described with reference to FIG. 10. Note that the internal window engine 106 repeatedly performs a process illustrated in FIG. 10.

First, the internal window engine 106 determines whether a touch event has been notified by the display controller 104 (step S140). When determining that a touch event has not been notified, the internal window engine 106 repeatedly performs a process in step S140 (step S140; No).

On the other hand, when a touch event has been notified, the internal window engine 106 determines whether a touch operation has been performed on the transparent region based on operation information transmitted together with the touch event (step S140; Yes→step S142). When a touch operation is not performed on the transparent region, the internal window engine 106 processes the touch operation as a touch operation on the internal window (step S142; No→step S144). On the other hand, when a touch operation has been performed on the transparent region, the internal window engine 106 notifies the browser controller 110 of the touch event notified in step S140 as a touch event for the external window through the IMP communication (WebSocket) (step S142; Yes→step S146).

### 1.3.5 External Window Engine

When the external window engine 108 performs a process for a touch operation based on a touch event when the touch event for the external window has been notified by the display controller 104.

In this way, by executing the processes shown in FIGS. 7 to 10, the operation performed on the transparent region is notified to the external window engine 108 as a touch event for the external window, and the operation is processed as an operation on the external window.

Furthermore, an operation on a region other than the transparent region is processed by the internal window engine 106 as an operation on the internal window.

### 1.4 Operation Example

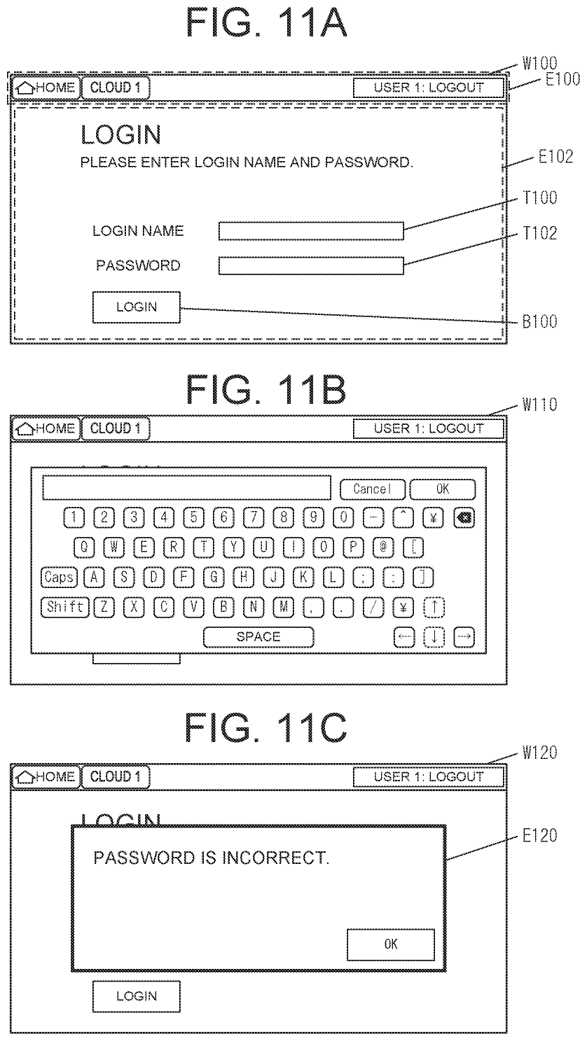

A description will be made on an operation example in this embodiment. FIG. 11A is an example of a login screen W100. The login screen W100 is displayed when user authentication is set to be valid in a setting screen of the image-forming apparatus 10. The login screen W100 includes a system region E100 and a content display region E102. Content of the login screen is displayed on the content display region E102. The content of the login screen includes a login name input field T100, a password input field T102, and a button B100 for performing login.

FIG. 11B is a diagram illustrating a display example of a display screen W110 displayed when the login name input field T100 or the password input field T102 is touched. When one of the input fields is touched, the image-forming apparatus 10 of this embodiment displays a software keyboard in the internal window. A function of the software keyboard is typically provided by the OS or platform, but may not be provided in a case of embedded devices, such as the image-forming apparatus 10. In this case, the image-forming apparatus 10 uses HTML and JavaScript in the internal window to realize a software keyboard function.

FIG. 11C is a diagram illustrating an example of the display screen W120 when a dialog E120 is displayed. The dialog E120 is displayed when predetermined information is informed to the user when a password entered in a login screen W100 is incorrect or the like. When a function of displaying a dialog is not provided by the OS or the platform, the image-forming apparatus 10 realizes the function of displaying a dialog using HTML and JavaScript on the internal window.

Note that, in this specification, the software keyboard and the dialog are referred to as native GUIs (Graphical User Interfaces). Such a native GUI is a component as an input object (a GUI or a UI (User Interface) part) that allows a user to perform a specified input operation, such as an operation of selecting a button or an operation of inputting character strings. The image-forming apparatus 10 realizes (displays) a component (an input object) having a function equivalent to the native GUI using the internal window to realize an input function. In the following description, a component (an input object) that achieves the same function as the native GUI displayed in the internal window is simply described as a native GUI.

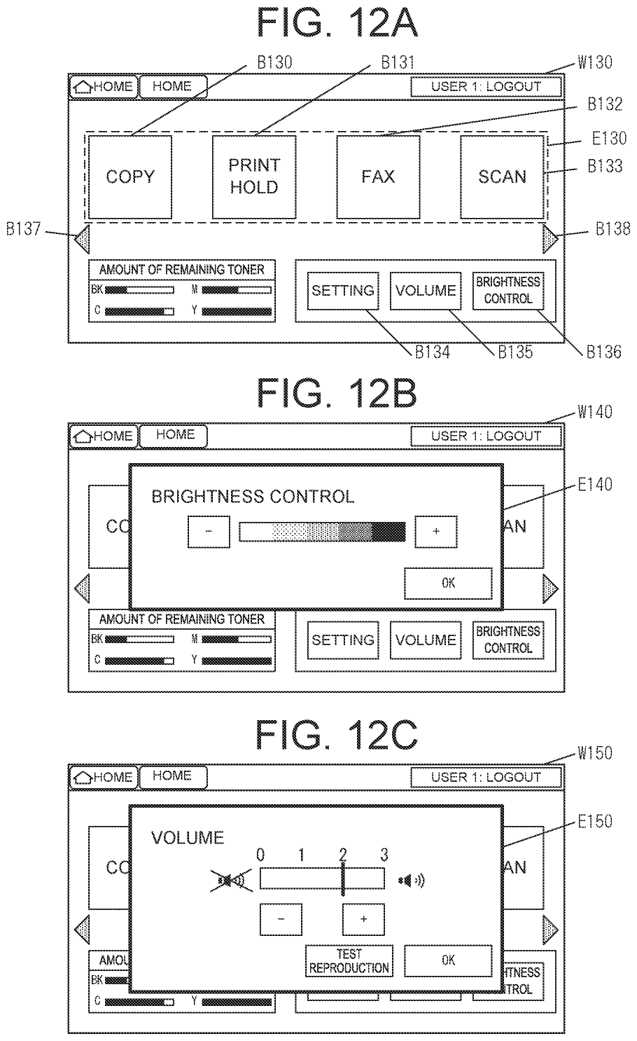

FIG. 12A is a diagram illustrating an example of the home screen W130 that is an initial screen displayed when login is successfully performed or when the user authentication is set to be invalid in the setting screen. The home screen includes a region E130 having function buttons, for example. The function buttons are used to select functions to be executed by the image-forming apparatus 10. The region E130 includes four function buttons, that is, a copy function button B130, a print hold function button B131, a facsimile function button B132, and a scan function button B133, for example. The home screen W130 further includes a button B134 for displaying the setting screen, a button B135 for controlling volume, and a button B136 for controlling brightness of the display 140.

Change in placement of the function buttons and addition of function buttons may be performed on the home screen W130 through the setting screen. When all the function buttons may not be simultaneously displayed on one screen, the region E130 is scrolled in a horizontal direction on the home screen W130 by an operation of selecting one of triangular buttons (buttons B137 and B138) or a flick/scroll operation.

FIG. 12B is a diagram illustrating an example of a display screen W140 that is displayed when the button B136 is selected on the home screen W130. The display screen W140 includes a pop-up window E140 for controlling brightness. Furthermore, FIG. 12C is a diagram illustrating an example of a display screen W150 that is displayed when the button B135 is selected on the home screen W130. The display screen W150 includes a pop-up window E150 for controlling volume. The pop-up window E140 and the pop-up window E150 are realized using and JavaScript.

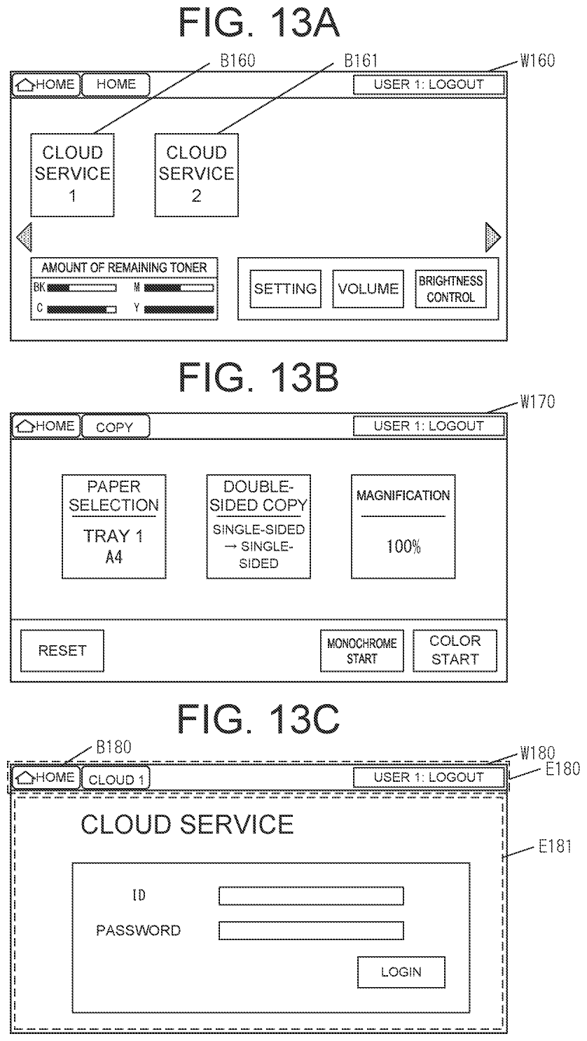

FIG. 13A is a diagram illustrating a home screen W160 displayed when the button B138 that is the rightward triangular button is selected on the home screen W130 of FIG. 12A so that the region E130 is scrolled rightward on the home screen W130. The home screen W160 includes, as function buttons, a function button B160 for displaying content of the cloud service 1 and a function button. B161 for displaying content of the cloud service 2. The user can use a cloud service (external content) by selecting the function button B160 or the function button B161.

FIG. 13B is a diagram illustrating an example of an operation screen W170 displayed when the copy function button B130 is selected on the home screen W130 of FIG. 12A. The copy function is a native function provided by the image-forming apparatus 10. The operation screen W170 for the copy function is internal content and is displayed in the internal window.

FIG. 13C is a diagram illustrating an example of an operation screen W180 displayed when the function button B160 of the cloud service 1 is selected on the home screen W160 of FIG. 13A, and displayed as an authentication screen of the cloud service 1. Here, a system region E180 that is an upper region in the internal window is displayed without transparency. The system region E180 includes, for example, a home button B180 for switching the operation screen W180 to the home screen. On the other hand, a content region E181 that is a lower region in the internal window is a transparent region. Therefore, a screen of an external cloud service is displayed in the content region E181.

The user may perform a touch operation on the operation screen W180. Here, when the user performs an operation of touching a region (the system region E180) other than the transparent region in the internal window, the operation is processed as a touch operation on the internal window. Therefore, when the home button B180 included in the system region E180 is touched by the user, the image-forming apparatus 10 determines that the home button B180 has been touched, and then, switches the operation screen W180 to the home screen. On the other hand, when the user performs a touch operation on the transparent content region E181 (the transparent region), the operation is processed as a touch operation on the external window by the image-forming apparatus 10.

Note that, although the process of issuing a notification of a touch operation (a touch event) is described in the embodiment described above, a mouse operation (a mouse event) may also be notified by the same process.

As described above, although the image-forming apparatus of this embodiment is configured by the two windows including the internal window and the external window, the user can perform a touch operation or the like as if the image-forming apparatus has a one-screen configuration.

Here, the image-forming apparatus of this embodiment displays external content on the external window that is different from the internal window displaying internal content. Accordingly, the image-forming apparatus of this embodiment may cope with a case where cross-domain restrictions disable display of content in the apparatus and content out of the apparatus using iframe tags.

In general, to avoid cross-domain restrictions, a setting of the external HTTP server for allowing cross-domains is required. However, in this case, there arises problems in that a burden of management of external content (an external HTTP server side) is increased and a case where a change in settings of the external HTTP server (a cloud service side) is not allowed may not be cope with. In particular, the external HTTP server may have cross-domain restrictions to prevent clickjacking when content is displayed using iframe tags, and accordingly, degradation of security may occur due to a change in settings. To address these problems, the image-forming apparatus of this embodiment is configured to have two windows as UIs in the image-forming apparatus (a client side) without changing settings of the external HTTP server. Furthermore, although the image-forming apparatus of this embodiment has the two-window configuration, the user can perform a touch operation as if the touch operation is performed on one screen so that usability is improved. Although the image-forming apparatus of this embodiment has the two-window configuration, a touch operation for switching windows is not required and the user can perform a seamless touch operation so that usability of the one-window configuration is not impaired.

### 2. Second Embodiment

A second embodiment will now be described. In the second embodiment, in addition to the processes described in the first embodiment, a process for realizing a native GUI for an external window based on an operation performed on the external window is executed.

In the first embodiment, the native GUI is displayed on the internal window. On the other hand, a native GUI may not be displayed in an external window (one window). This is clue to restrictions of iframe or the like, and specifically, a software keyboard serving as internal content may not be displayed on a web browser (an external window) displaying external content. In this way, native GUIs to be displayed on the same window may not be displayed on the same window.

Therefore, the image-forming apparatus 10 of this embodiment realizes a native GUI in a dedicated window (an internal window) that ensures security, and allows the native GUI to be used through an external window, thereby realizing the native GUI by a browser while ensuring security. Accordingly, the image-forming apparatus 10 allows a user to perform input operations on external content, and to reflect content input by the user in the external content.

In this embodiment, native GUIs to be realized in the internal window are as follows.

### (1) Software Keyboard

A software keyboard is realized by software such that individual keys generally arranged on a keyboard, an OK button, and a Cancel button are displayed. Input content (character strings) input using the individual keys is reflected in content displayed in the internal window or the external window when the user selects the OK button.

### (2) Dialogs

A dialog is a window (a dialog box) that displays information or that is displayed to request the user to select a button or input information. In this embodiment, the following four types of dialogs are displayed as dialogs.

### (2-1) JavaScript Alert Dialog

A JavaScript alert dialog includes a message and an OK button. The JavaScript alert dialog is displayed when a process of displaying the alert dialog is executed in a JavaScript program.

### (2-2) JavaScript Confirmation Dialog

A JavaScript confirmation dialog includes a message, an OK button, and a Cancel button. The JavaScript confirmation dialog is displayed when a process of displaying the confirming dialog is executed in the JavaScript program.
(2-3) JavaScript prompting Dialog
A JavaScript prompting dialog includes a message, a character string input field, an OK button, and a Cancel button. The JavaScript prompting dialog is displayed when a process of displaying the prompting dialog is executed in the JavaScript program.

### (2-4) Authentication Dialog

An authentication dialog is displayed when a server of content returns HTTP 401 (authentication failure, an HTTP response having an HTTP response code of 401). The authentication dialog includes two input fields for inputting authentication information, that is, a character string input field for inputting an account name and a character string input field for inputting a password, in addition to an OK button and a Cancel button.

Note that, in this embodiment, the JavaScript alert dialog, the JavaScript confirmation dialog, and the JavaScript prompting dialog are described as JavaScript dialogs.

### 2.1 Flow of Information

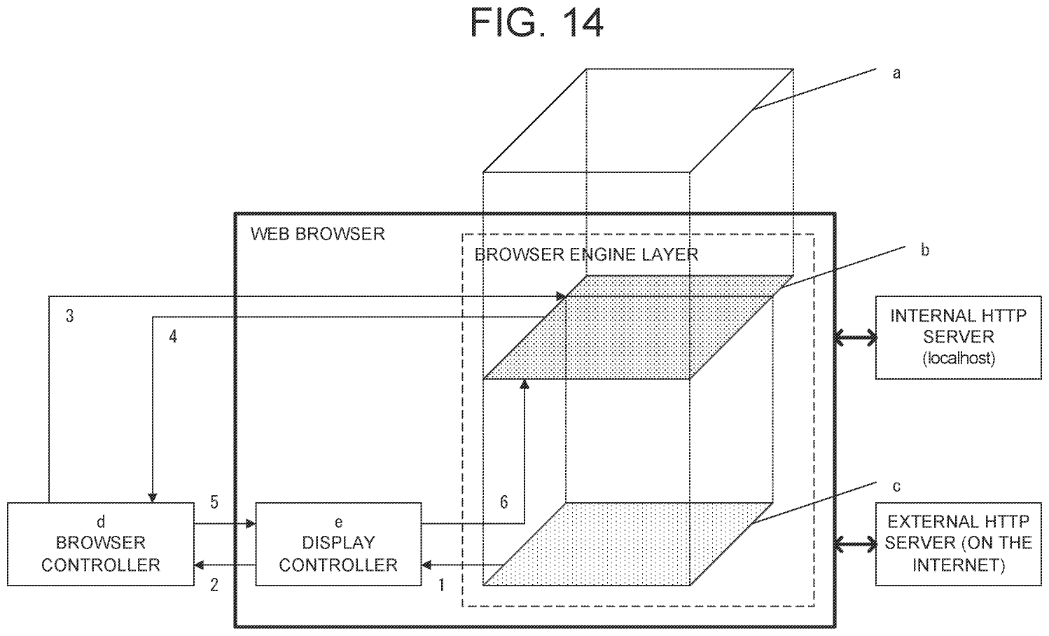

FIG. 14 is a diagram illustrating a route of a notification of an internal event (information) of the image-forming apparatus 10 employed when an operation of calling a native GUI through the external window (such as an operation of displaying the software keyboard or a process of displaying a dialog) is performed. Note that a through e in FIG. 14 are the same functional portions as a through e in FIG. 6.

First, a web browser (the external window, detects an operation or a process of displaying a native GUI. At this time, an external window engine 108 transmits a request for displaying a native GUI (a native GUI activation request) to a display controller 104 (1 of FIG. 14). The display controller 104 transmits the native GUI activation request to a browser controller 110 (2 of FIG. 14). The browser controller 110 transmits the native GUI activation request to an internal window engine 106 using HTTP communication (WebSocket) (3 of FIG. 14). The internal window engine 106 that has received the native GUI activation request displays a native GUI in the internal window.

After the user completes an operation for the native GUI, the internal window engine 1.06 notifies the browser controller 110 that the operation for the native GUI has been terminated (a result of the operation for the native GUI) using the HTTP communication (WebSocket) (4 of FIG. 14). The browser controller 110 notifies the browser (the display controller 104) that the operation for the native GUI has been terminated (an operation result) using inter-process communication (5 of FIG. 14). The web browser (the display controller 104) reflects the operation result in external content (6 of FIG. 14).

### 2.2 Processing Flow

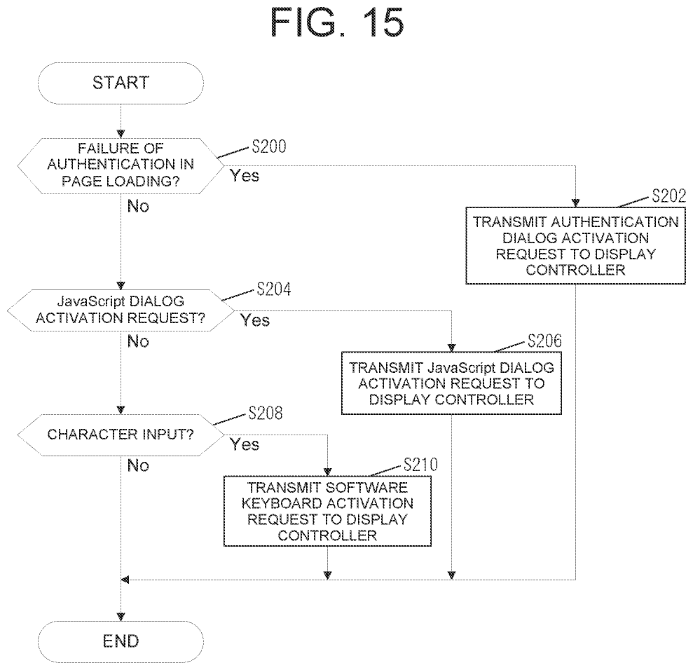

Next, referring to FIGS. 15 to 19, flows of processes executed by the image-forming apparatus 10 will be described. The processes illustrated in FIGS. 15 to 19 are executed when the controller 100 reads a program stored in the storage 160. The processes illustrated in FIGS. 15 to 19 are executed in parallel with the processes of the first embodiment illustrated in FIGS. 7 to 10.

### 2.2.1 External Window Engine (Determination Process)

A determination process executed by the external window engine 108 will be described with reference to FIG. 15. The determination process determines whether an operation or a process of displaying a native GUI has been performed. Note that the external window engine 108 repeatedly performs the process illustrated in FIG. 15.

First, the external window engine 108 determines whether authentication has failed during page loading (content acquisition) (step S200). For example, the external window engine 108 determines that authentication has failed when an external HTTP server returns an HTTP response having an HTTP response code of 401. When authentication has failed, the external window engine 108 notifies the display controller 104 of a native GUI activation request for an authentication dialog (step S200; Yes→step S202).

On the other hand, when the authentication does not fail in the page loading, the external window engine 108 determines whether the native GUI activation request for a JavaScript dialog has been issued (step S200; No→step S204). The native GUI activation request for a JavaScript dialog is issued to display the alert dialog, the confirmation dialog, and the prompting dialog when the JavaScript program executes processes of displaying these dialogs. When the native GUI activation request for a JavaScript dialog has been issued, the external window engine 108 transmits the native GUI activation request for a JavaScript dialog to the display controller 104 (step S204; Yes→step S206).

On the other hand, when the native GUI activation request for a JavaScript dialog has not been issued, the external window engine 108 determines whether an operation of inputting characters has been performed (step S204; No→step S208). For example, the external window engine 108 determines that an operation of inputting characters has been performed when an operation of touching a character string input field displayed by input tags or text area tags has been performed. When the operation of inputting characters has been performed, the external window engine 108 notifies the display controller 104 of a native GUI activation request for a software keyboard (step S208; Yes→step S210). Note that, when the operation of inputting characters has not been performed, the external window engine 108 omits the process in step S210 (step S208; No).

### 2.2.2 External Window Engine (Result Reflection Process)

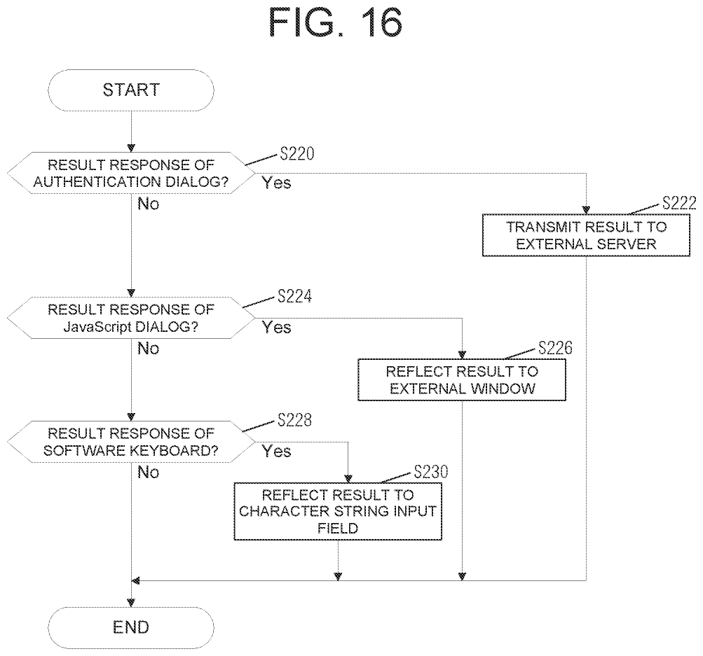

A result reflection process executed by the external window engine 108 will be described with reference to FIG. 16. The result reflection process reflects a result response (an operation result) to the native GUI in the external window. Note that the external window engine 108 repeatedly performs the process illustrated in FIG. 16.

First, the external window engine 108 determines whether a result response to the native GUI of the authentication dialog has been notified (step S220). The result response to the native GUI of the authentication dialog is information including, for example, an account name and a password input via the authentication dialog. When the result response to the native GUI of the authentication dialog has been notified, the external window engine 108 notifies the external HTTP server of a result (the input account name and the input password) (step S220; Yes→step S222). Note that, when the authentication by the external HTTP server has been successfully performed, the display controller 104 and the external window engine 108 continuously performs a process of acquiring content from the external HTTP server and displaying the acquired content.

On the other hand, when the result response to the native GUI of the authentication dialog has not been notified, the external window engine 108 determines whether a result response to the native GUI of the JavaScript dialog has been notified (step S220; No step S224). The result response to the native GUI of the JavaScript dialog is information including, for example, information indicating a selected button or information on an input character string. When the result response to the native GUI of the JavaScript dialog has been notified, the external window engine 108 reflects a button selected by the user or a character string input by the user in the external content (step S224; Yes→step S226).

On the other hand, when the result response to the native GUI of the JavaScript dialog has not been notified, the external window engine 108 determines whether a result response to the native GUT of a software keyboard has been notified (step S224; No→step S228). The result response to the native GUI of a software keyboard is information including, for example, information on a character string input by the user. When the result response to the native GUI of a software keyboard has been notified, the external window engine 108 reflects a character string input by the user in the character string input field selected in step S208 of FIG. 15 (step S228; Yes→step S230), Note that, when the result response to the native GUI of a software keyboard has not been notified, the external window engine 108 omits the process in step S230 (step S228; No).

### 2.2.3 Display Controller

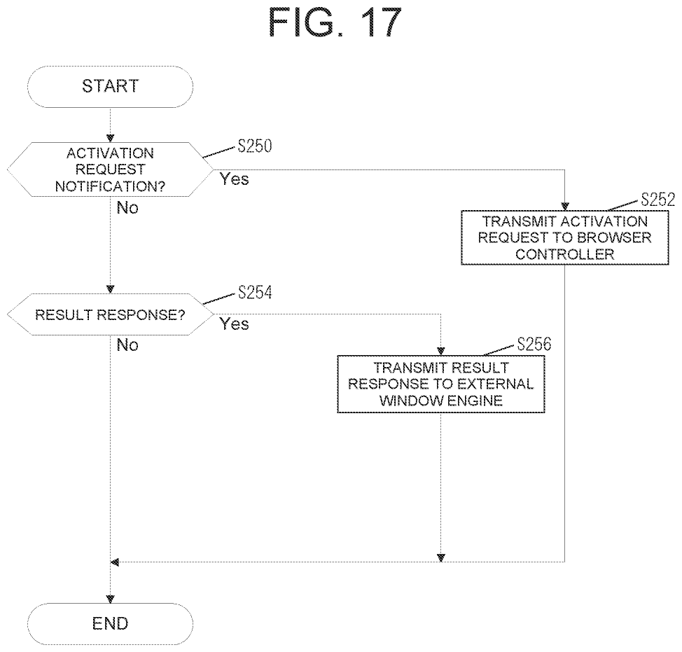

A process executed by the display controller 104 will be described with reference to FIG. 17. Note that the display controller 104 repeatedly performs the process illustrated in FIG. 17.

First, the display controller 104 determines whether a native GUI activation request has been notified from the external window engine 108 (step S250). When the native GUI activation request has been notified, the display controller 104 notifies the browser controller 110 of the native GUI activation request through inter-process communication (step S250; Yes→step S252).

On the other hand, when the native GUI activation request has not been notified, the display controller 104 determines whether a result response to the native GUI has been notified from the browser controller 110 (step S250; No→step S254). When the result response has been notified, the display controller 104 notifies the external window engine 108 of the notified result response to the external window engine 108 (step S254; Yes→step S256). Note that, when the result response to the native GUI has not been notified, the display controller 104 omits the process in step S256 (step S254; No).

### 2.2.4 Browser Controller

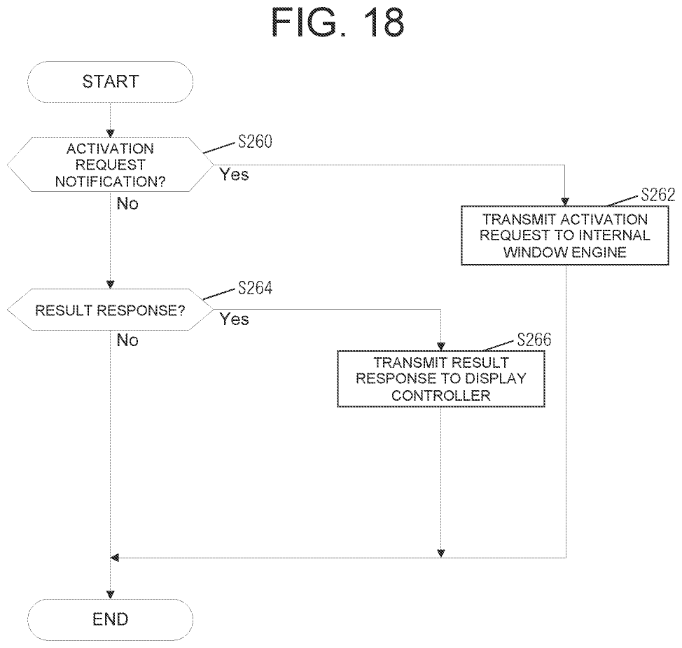

A process performed by the browser controller 110 will be described with reference to FIG. 18. The browser controller 110 repeatedly performs a process illustrated in FIG. 18.

First, the browser controller 110 determines whether a native GUI activation request has been notified by the display controller 104 (step S260). When the native GUI activation request has been notified, the browser controller 110 notifies the internal window engine 106 of the native GUI activation request through HTTP communication (WebSocket) (step S260; Yes→step S262).

On the other hand, when the native GUI activation request has not been notified, the browser controller 110 determines whether a result response to the native GUI has been notified from the internal window engine 106 (step S260; No→step S264). When the result response to the native GUI has been notified, the browser controller 110 notifies the web browser (the display controller 104) of the notified result response through the inter-process communication (step S264; Yes→step S266). Note that, when the result response to the native GUI has not been notified, the browser controller 110 omits the process in step S266 (step S264; No).

### 2.2.5 Internal Window Engine

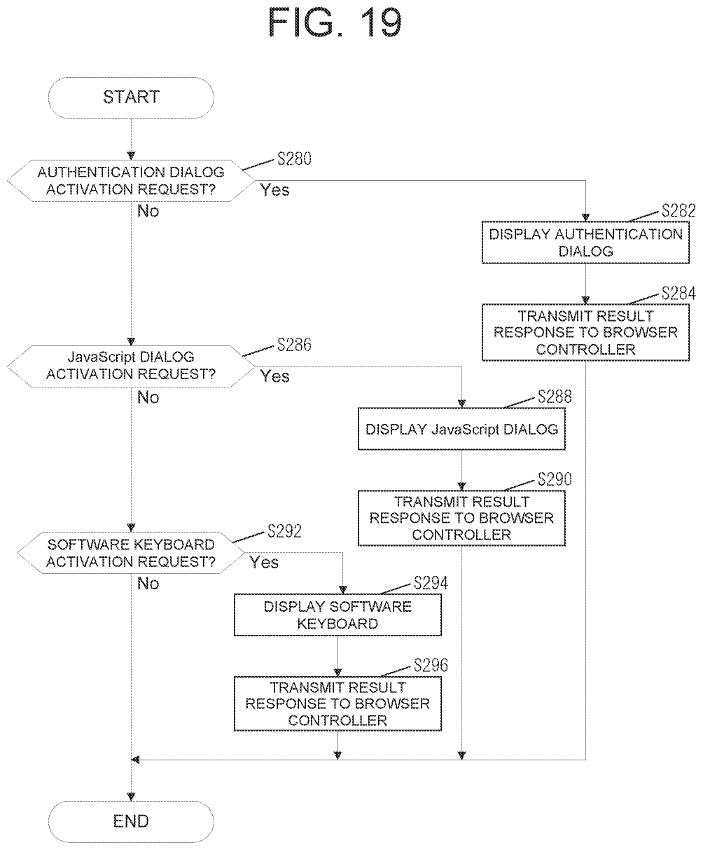

A process executed by the internal window engine 106 will be described with reference to FIG. 19. Note that the internal window engine 106 repeatedly performs a process illustrated in FIG. 19.

First, the internal window engine 106 determines whether a native GUI activation request of an authentication dialog has been notified from the browser controller 110 (step S280). When the native GUI activation request of an authentication dialog has been notified, the internal window engine 106 displays the authentication dialog in the internal window (step S280; Yes→step S282). At this time, the internal window engine 106 sets a region other than the system region and a region displaying the authentication dialog as a transparent region. Accordingly, the authentication dialog is superimposed on the external content.

The internal window engine 106 notifies the browser controller 110 of a result response using the HTTP communication (WebSocket) (step S284) when an operation on the authentication dialog is terminated. For example, when the user selects an OK button, the internal window engine 106 notifies the browser controller 110 of a result response including an account name and a password that are input by the user. Furthermore, when the user selects a Cancel button, the internal window engine 106 notifies the browser controller 110 of a result response including information indicating that the Cancel button has been selected.

On the other hand, when the native GUI activation request of the authentication dialog has not been notified, the internal window engine 106 determines whether a native GUI activation request of the JavaScript dialog has been notified from the browser controller 110 (step S280; No→step S286). When the native GUI activation request of the JavaScript dialog has been notified, the internal window engine 106 displays a requested type of JavaScript dialog in the internal window (step S286; Yes→step S288). At this time, the internal window engine 106 sets a region other than the system region and a region displaying the JavaScript dialog as a transparent region.

The internal window engine 106 notifies the browser controller 110 of a result response using the HTTP communication (WebSocket) when an operation for the JavaScript dialog is terminated (step S290). For example, the internal window engine 106 notifies the browser controller 110 of a result response including information indicating a button selected by the user or information on a character string input by the use.

On the other hand, when the native GUI activation request of the JavaScript dialog has not been notified, the internal window engine 106 determines whether a native GUI activation request of a software keyboard has been notified by the browser controller 110 (step S286; No→step S292). When the native GUI activation request of a software keyboard has been notified, the internal window engine 106 displays a software keyboard in the internal window (step S292; Yes→step S294). At this time, the internal window engine 106 sets a region other than the system region and a region displaying the software keyboard as a transparent region.

The internal window engine 106 notifies the browser controller 110 of a result response using the HTTP communication (WebSocket) when an operation on the software keyboard is terminated (step S296). For example, when the user selects an OK button, the internal window engine 106 notifies the browser controller 110 of a result response including a character string input by the user and information indicating that the OK button has been selected. Furthermore, when the user selects a Cancel button, the internal window engine 106 notifies the browser controller 110 of a result response including information indicating that the Cancel button has been selected. Note that, when the native GUI activation request of a software keyboard has not been notified, the internal window engine 106 omits the process in step S294 and step S296 (step S292; No).

### 2.3 Operation Example

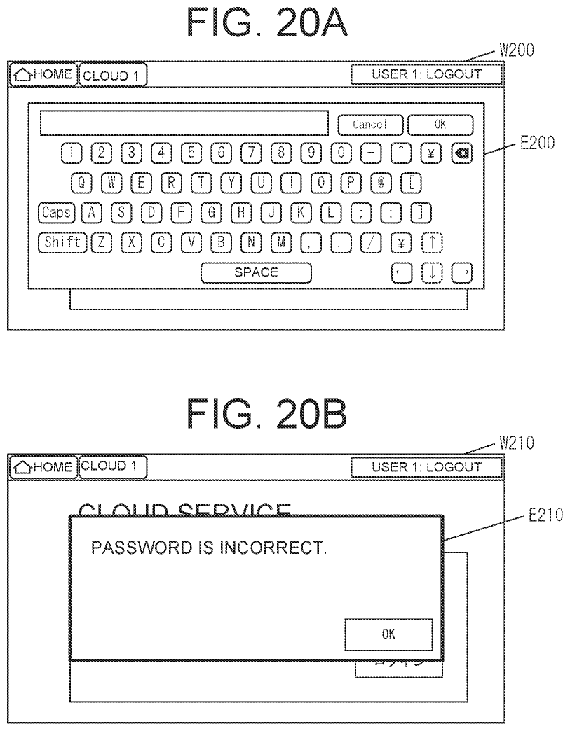

Referring to FIG. 20A and 20B, an operation example according to this embodiment be described. FIG. 20A is a diagram illustrating an example of a display screen W200 displaying a software keyboard E200 in the internal window. The software keyboard E200 serving as a native GUI is displayed in the internal window when a character string input field for an account name (ID), a password, or the like is touched in content of a cloud service displayed in the external window. The internal window displays the system region on an upper side and the software keyboard and sets other regions as transparent regions. Accordingly, the software keyboard is superimposed on external content.

FIG. 20B is a diagram illustrating an example of a display screen W210 displaying a JavaScript dialog E210 in the internal window. The JavaScript dialog E210 is displayed, for example, when a password input by the user is incorrect. The JavaScript dialog E210 is displayed in the internal window, similar to the software keyboard. In FIG. 20B, an alert dialog with a message “Password is incorrect” is displayed as an example.

Note that, although the native GUI is a software keyboard or a dialog in the embodiment described above, the native GUI may be other than a software keyboard or a dialog as long as the native GUI allows the user to perform an input operation on the external content. For example, the image-forming apparatus 10 may display a screen to allow the user to select a date and time or a screen to allow the user to input an e-mail address or a URL (Uniform Resource Locator) as the native GUI.

Thus, even when a native GUI is not provided by the operating system, the image-forming apparatus of this embodiment can appropriately display a native GUI and reflect operations on the native GUI.

### 3. Third Embodiment

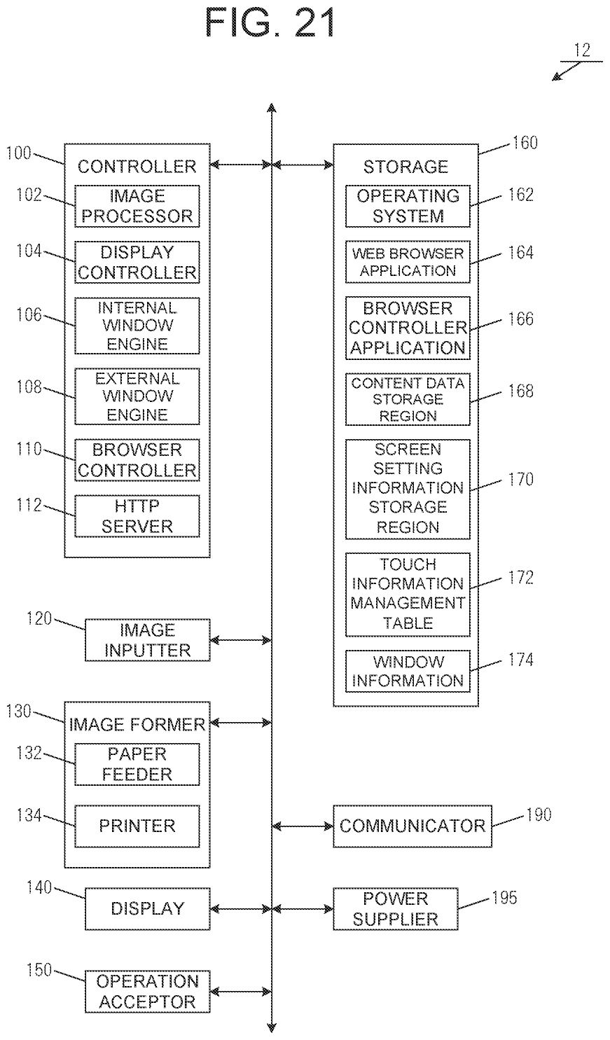

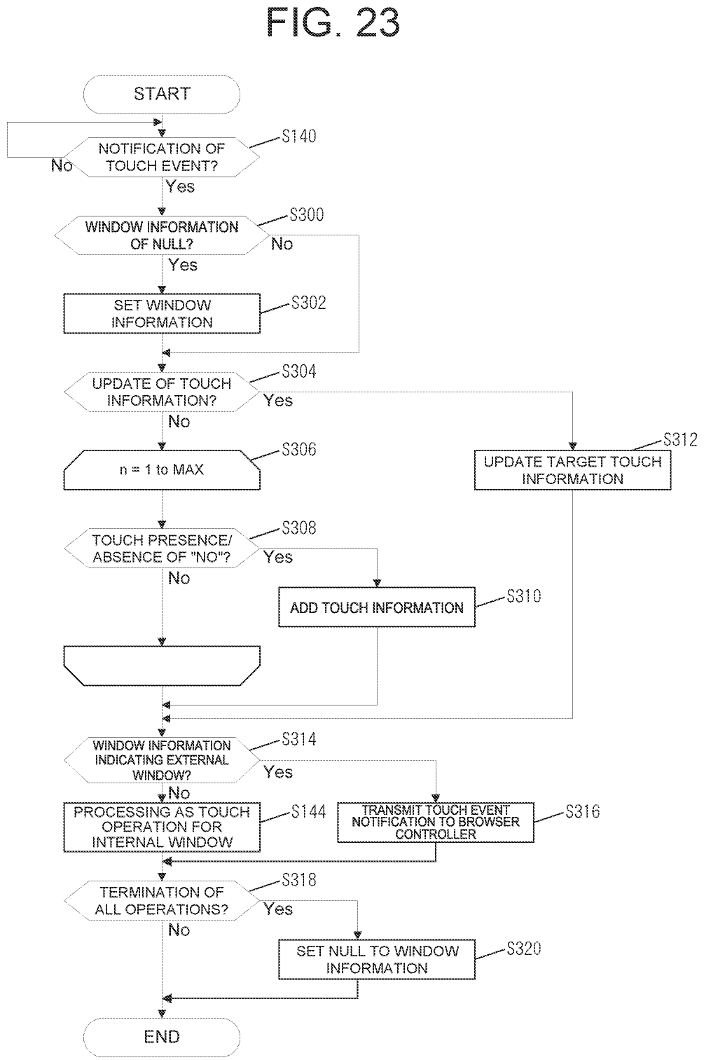

Next, a third embodiment will be described. In the third embodiment, in addition to the processes described in the first embodiment, a browser engine layer (an internal window engine) performs a process of managing a multi-touch operation. In this embodiment, FIG. 2 of the first embodiment is replaced with FIG. 21, and FIG. 10 of the first embodiment is replaced with FIG. 23. The same functional portions and processes are denoted by the identical numerical numbers and the descriptions thereof are omitted.

According to this embodiment, in a two-window configuration having an internal window and an external window, when a touch at a first point is started and the touch at the first point or a plurality of touches are made, all the touch operations are processed as one continuous touch operation, that is, a touch operation on a window on which the touch at the first point is performed until all the touch operations are completed.

In this embodiment, when touch operations are performed across the windows, that is, when a touch at a first point is performed and then another touch is performed on a window different from a window on which the touch at the first point is made, the touch operations are determined as a process performed on the window on which the first touch is started. Specifically, while a plurality of touch operations are processed as one continuous touch operation, the continuous touch operation is processed as a touch operation on the internal window or the external window.

### 3.1 Functional Configuration

With reference to FIG. 21, a functional configuration of an image-forming apparatus 12 according to this embodiment will be described. Compared to the image-forming apparatus 10 shown in FIG. 2, a storage 160 of the image-forming apparatus 12 further stores a touch information management table 172 and window information 174.

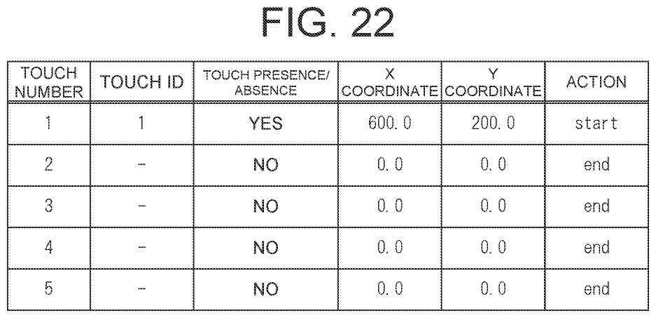

The touch information management table 172 is used to manage (store) information on touch operations. The touch information management table 172, for example, as shown in FIG. 22, stores a touch number (e.g., “1”) that identifies touch information, a touch ID (e.g., “1”) that is a unique number that identifies a point of contact with a touch surface (an operation acceptor 150), and touch presence/absence (e.g., “Yes”), an X coordinate (e.g., “600.0”) and a Y coordinate (e.g., “200.0”) that indicate touched coordinates, and an action of a touch (e.g., “start”) that are associated with one another.

The touch ID is obtained by an event handler of a JavaScript touch operation, for example. The coordinates are represented as (x, y) where a pixel in an upper left corner of the display 140 is set as an origin (0, 0), the number of pixels in a horizontal direction from the origin to a pixel of interest is set as x, and the number of pixels in a vertical direction from the origin to the pixel of interest is set as y. For example, in the touch information management table 172, a value from 0 to 639 is stored in the X coordinate and a value from 0 to 479 is stored in the Y coordinate. As the action, a value of “start”, “move”, or “end” is stored. The value “start” indicates that a touch position has been newly set (a touch operation has started). The value “move” indicates that the touch position has been moved. The value “end” indicates that the touch position has been cancelled (the touch operation has been terminated). Note that an initial value of the action is “end”.

Note that, in this embodiment, it is assumed that the operation acceptor 150 is a touch panel that allows touches at up to five points, and after a touch at a sixth point, sixth and subsequent touch events are not be notified. Therefore, information on up to five touch operations is managed, and the touch number is any value from 1 to 5.

The window information 174 indicates a window in which a touch at a first point is started. An initial value of the window information 174 is N and when the first point is touched, information indicating “Internal Window” or “External Window” is stored. When all touch operations are completed, NULL is stored in the window information 174.

### 3.2 Processing Flow

A process executed by the internal window engine 106 of this embodiment will be described with reference to FIG. 23. First, the internal window engine 106 determines whether the window information 174 indicates NULL when a touch window has been notified (step S300). The internal window engine 106 sets information indicating a touched window in the window information 174 when the window information 174 is NULL (step S300; Yes→step S302). For example, when a transparent portion of the internal window is touched, the internal window engine 106 stores “External Window” in the window information 174, and otherwise, stores “Internal Window” in the window information 174. Note that, Then the window information 174 is not NULL, the internal window engine 106 omits a process in step S302 (step S300; No).

Subsequently, the internal window engine 106 determines whether to update touch information managed in the touch information management table 172 (step S304). The internal window engine 106 determines that, when an action of a touch operation corresponds to “move” or “end”, the touch information is to be updated. On the other hand, when an action of the touch operation is an operation corresponding to “start”, the internal window engine 106 determines that the touch information is not to be updated (touch information is added).

When the internal window engine 106 does not update the touch information, a variable n for a touch number is changed from 1 to a maximum value of the touch number (5 in this embodiment) (step S306). The internal window engine 106 refers to the touch information management table 172 to determine whether the touch presence/absence stored in the touch information having a touch number of the variable n is “No” (step S308). When the touch presence/absence indicates “No”, the internal window engine 106 stores a touch ID, coordinates, and an action based on a touch event notified in step S140 in the touch information having a touch number of the variable n and sets “Yes” in the touch presence/absence. By this, the internal window engine 106 adds touch information to the touch information management table 172 (step S310).

On the other hand, when updating the touch information (step S304; Yes), the internal window engine 106 acquires a touch ID based on the touch event notified in step S140. Then, the internal window engine 106 updates the touch information (touch information to be updated) storing the touch ID based on the touch event notified in step S140 (step S312). Here, when the touch operation corresponds to “end”, the internal window engine 106 stores “0.0” in X and Y coordinates of the touch information to be updated and sets “No” as the touch presence/absence so that the touch information is initialized (cleared).

Thereafter, the internal window engine 106 determines whether the window information 174 stores “External Window” (step S314). When “External Window” is not stored in the window information 174, the internal window engine 106 processes an operation based on the touch information stored in the touch information management table 172 as a touch operation on the internal window (step S314; No→step S144). On the other hand, when “External Window” is stored in the window information 174, the internal window engine 106 notifies the browser controller 110 of an operation based on the touch information stored in the touch information management table 172 (a touch event) as a touch event for the external window (step S314; Yes→step S316). At this time, the internal window engine 106 subtracts a value corresponding to a height of the system region from information on the Y coordinate and notifies the browser controller 110 of a resultant value.

Subsequently, the internal window engine 106 determines whether all actions of the touch information stored in the touch information management table 172 indicate “end” (step S318). The internal window engine 106 sets NULL in the window information 174 when all the actions of the touch information indicate “end” (step S318; Yes→step S320). Note that, when at least one of the actions of the touch information does not indicate “end”, the internal window engine 106 omits a process in step S320 (step S318; No).

Thus, the internal window engine 106 determines that other touch operations performed after a start of a touch operation at a first point and before an end of the touch operation and touch operations performed in chain to the other touch operations to be touch operations on a window in which the touch operation at the first point was performed. As a result, the internal window engine 106 can process the series of touch operations as an operation on the window corresponding to a touch position at the first point.

For example, after a touch operation on a transparent region (the external window) is started, other touch operations may be performed before the touch operation is terminated. In this case, the internal window engine 106 notifies the display controller 104 of information (a touch event) on the other touch operations and the touch operations performed before the other touch operations are terminated (the touch operations performed in chain to the other touch operations). Accordingly, when other touch operations are performed after a touch operation is started on a transparent region (the external window), the internal window engine 106 processes touch operations performed until all the touch operations are completed as an operation on the external window. Similarly, in a case where a touch operation on a region (the internal window) other than the transparent region is started, when other touch operations are performed after the touch operation is started, the internal window engine 106 processes touch operations performed until all the touch operations are terminated as touch operations on the internal window.

### 3.3 Operation Example

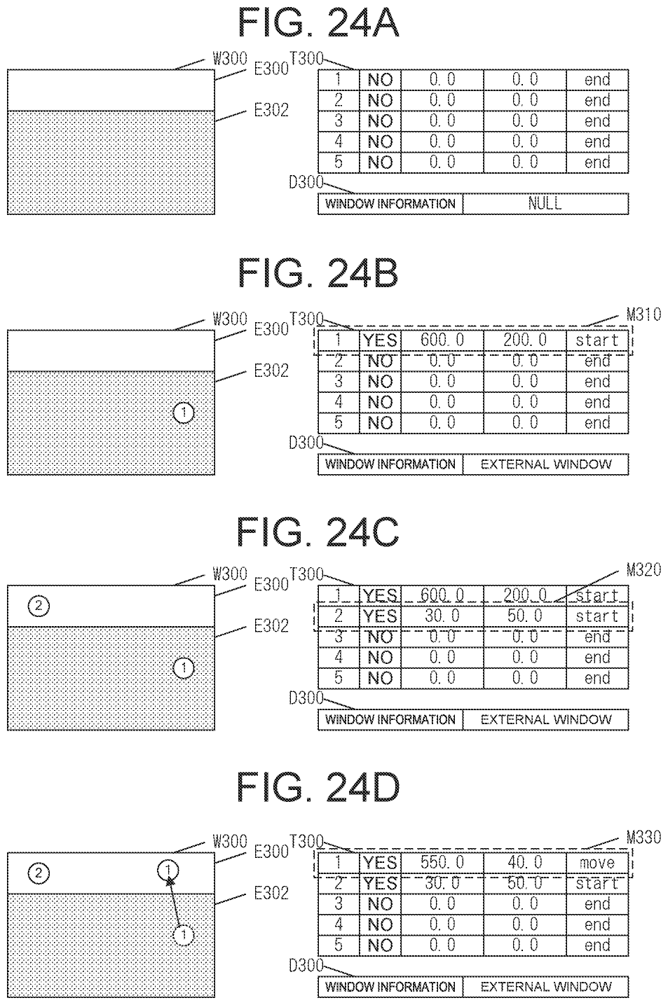

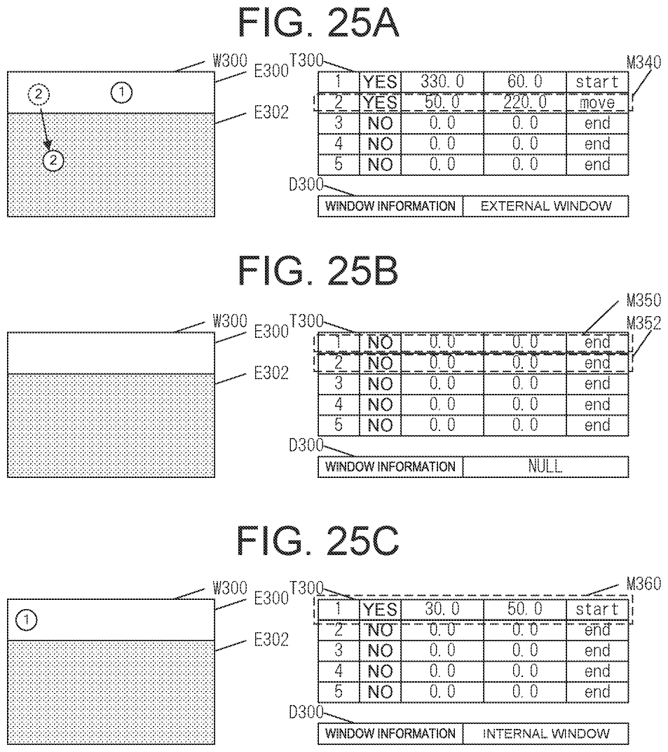

Referring to FIGS. 24A to 24D and FIGS. 25A to 25C, an operation example according to this embodiment will be described. FIGS. 24A to 24D and FIGS. 25A to 25C are diagrams illustrating a display screen W300 including a region E300 displaying the internal window and a region E302 displaying the external window (a transparent region in the internal window), content T300 stored in the touch information management table 172, and content D300 stored in the window information 174. The content T300 includes, from left to right, a touch number, a touch presence/absence, an X coordinate, a Y coordinate, and an action, and numbers included in the display screen W300 correspond to the touch number.

FIG. 24A is a diagram illustrating a case where a touch operation is not performed. When no touch operation is performed, touch information stored in the touch information management table 172 is cleared and the window information 174 stores NULL.

FIG. 24B is a diagram illustrating a case where a touch operation at a first point is performed on the external window. As illustrated in the content T300 in FIG. 24B, first point touch information (M310) is added to the touch information management table 172. Also, as illustrated in the content D300 in FIG. 24B, the window information 174 stores “External Window”.

FIG. 24C is a diagram illustrating a case where a touch operation at a second point is newly performed while the touch operation at the first point is being performed. As illustrated in the content T300 in FIG. 24C, second point touch information (M320) is added to the touch information management table 172. On the other hand, as illustrated in the content D300 in FIG. 24C, the window information 174 still stores “External Window”. In this case, the touch operation at the first point and the touch operation at the second point are processed as touch operations on the external window.

FIG. 24D is a diagram illustrating a case where a position touched by the touch operation at the first point is moved to a region displaying the internal content (the internal window). As illustrated in the content T300 in FIG. 24D, first point touch information (M330) in the touch information management table 172 is updated, and coordinates of the touched position after the move and the action (“move”) are stored in the touch information.

FIG. 25A is a diagram illustrating a case where a position touched by the touch operation at the second point is moved to a region displaying the external content (the external window). As illustrated in the content T300 in FIG. 25A, second point touch information (M340) in the touch information management table 172 is updated, and coordinates of the touched position after the move and the action (“move”) are stored in the touch information.

Note that the touch operation based on the touch information in FIG. 24D and the touch operation based on the touch information in FIG. 25A are both processed as touch operations on the external window. FIG. 25B is a diagram illustrating a case where all touch operations have been terminated. First point touch information (M350) and second point touch information (M352) are cleared, and the situation is the same as in FIG. 24A. At this time, when a touch operation is newly performed, as shown in FIG. 25C, the touch information management table 172 stores first point touch information (M360) and a window touched at a first point (“Internal Window” in the example of FIG. 25C).

Note that, when the window information 174 indicates “Internal Window,” the internal window engine 106 processes the touch operation based on the touch information stored in the touch information management table 172. On the other hand, when the window information 174 is “External Window,” the internal window engine 106 notifies the browser controller 110 of the touch information stored in the touch information management table 172. The touch information is notified from the browser controller 110 to the external window engine 108 via the display controller 104, and therefore, the external window engine 108 processes the touch operation based on the notified touch information.

Note that, in a case where a touch operation is started on a first window, and then, terminated on a second window, that is, across the windows, the internal window engine 106 may determine that a drag and drop has been performed, and supplies information that was selected when the touch operation was started to the second window.

In this way, when a multi-touch operation is performed, the image-forming apparatus of this embodiment can process a series of touch operations input until all touch operations are completed after start of touch as an operation on the window corresponding to the touch position at the first point. Accordingly, even when a touch position is moved across the windows by a swipe operation or a pinch-out operation, for example, the image-forming apparatus of this embodiment may process the operation as an operation on the window corresponding to a position where the touch operation is started.

### 4. Fourth Embodiment

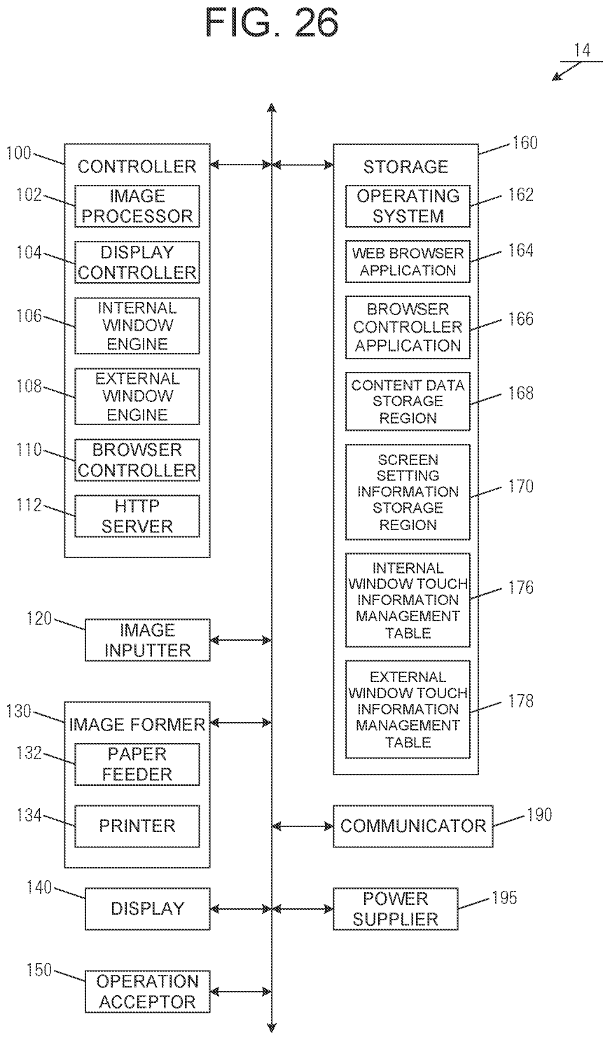

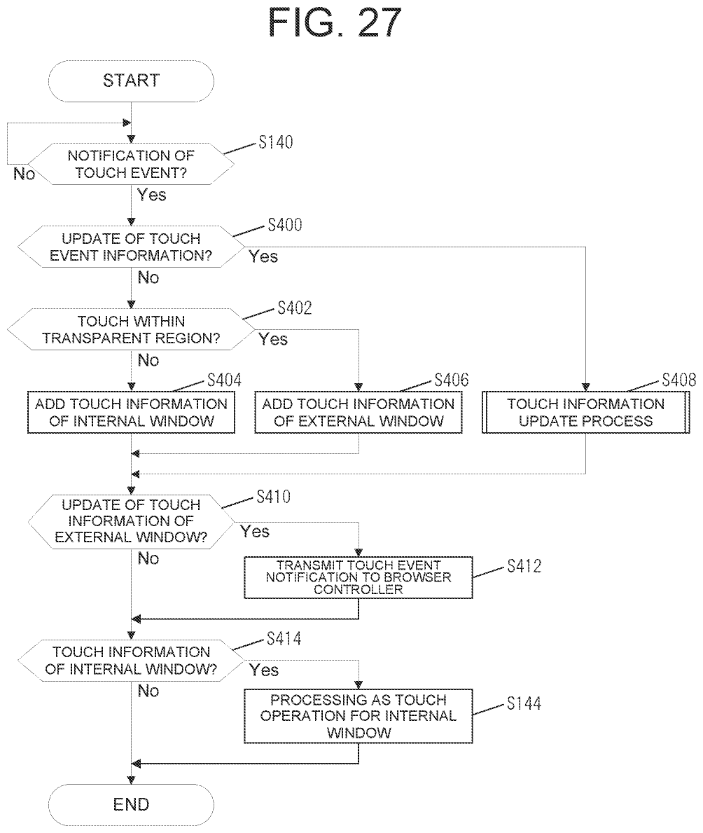

Next, a fourth embodiment will be described. In the fourth embodiment, a multi-touch operation is managed by a method different from the management of multi-touch operation in the third embodiment. In this embodiment, FIG. 2 of the first embodiment is replaced with FIG. 26, and FIG. 10 of the first embodiment is replaced with FIG. 27. The same functional portions and processes are denoted by the identical numerical numbers and the descriptions thereof are omitted.

In this embodiment, when touch operations are continuously performed across windows, it is determined that the touch operation. performed before crossing the window has been terminated and the touch operation after crossing the window corresponds to a start of touch on the window being touched. That is, in this embodiment, touches in the individual windows are managed as processes on the respective windows.

### 4.1 Functional Configuration

A functional configuration of an image-forming apparatus 14 according to this embodiment will be described with reference to FIG. 26. Compared to the image-forming apparatus 10 shown in FIG. 2, a storage 160 of the image-forming apparatus 14 further stores an internal window touch information management table 176 and an external window touch information management table 178. The information stored in the internal window touch information management table 176 and the external window touch information management table 178 is the same as that in the touch information management table 172 of the third embodiment.

### 4.2 Processing Flow

A process executed by an internal window engine 106 of this embodiment will be described with reference to FIG. 27. First, the internal window engine 106 determines whether touch information is to be updated when a touch event is notified (step S400). The process in step S400 is similar to the process in step S304 in FIG. 23.

The internal window engine 106 determines whether a touched position is within a transparent region when the touch information is not to be updated (step S400; No→step S402). When the touched position is not within the transparent region, the internal window engine 106 adds touch information for the internal window (step S402; No→step S404). For example, the internal window engine 106 performs the same process as the process from step S306 to step S310 of FIG. 23, for example, so that a touch ID, coordinates, and an action are stored in, among touch information stored in the internal window touch information management table 176, touch information corresponding to touch presence/absence of “No”. On the other hand, when the touched position is within the transparent region, the internal window engine 106 adds touch information for the external window (step S402; Yes→step S406). The internal window engine 106 performs the same process as the process in step S404, for example, so that a touch ID, coordinates, and an action are stored in, among touch information stored in the external window touch information management table 178, touch information corresponding to touch presence/absence of “No”.

On the other hand, the internal window engine 106 executes a touch information update process when the touch information is to be updated (step S400; Yes→step S408). The touch information update process will be described later.

Thereafter, the internal window engine 106 determines whether the touch information of the external window has been updated (step S410). For example, when touch information is added or touch information is updated on the external window touch information management table 178, the internal window engine 106 determines that touch information of the external window has been updated. When touch information of the external window is updated, the internal window engine 106 notifies a browser controller 110 of an operation based on the touch information stored in the external window touch information management table 178 (a touch event) as a touch event for the external window (step S410; Yes→step S412). At this time, the internal window engine 106 subtracts a value corresponding to a height of the system region from information on the Y coordinate and notifies the browser controller 110 of a resultant value. On the other hand, when the touch information of the external window has not been updated, the internal window engine 106 omits a process in step S412 (step S410; No).

Furthermore, when touch information of the internal window exists, the internal window engine 106 processes a touch operation based on the touch information as a touch operation on the internal window (step S414; Yes→step S144). For example, the internal window engine 106 processes a touch operation based on the touch information corresponding to touch presence/absence of “Yes” among touch information stored in the internal window touch information management table 176 as a touch operation on the internal window. Note that, when touch information of the internal window does not exist (that is, when touch information corresponding to touch presence/absence of “Yes” is not stored in the internal window touch information management table 176), the internal window engine 106 omits the process in step S144 (step S414; No).

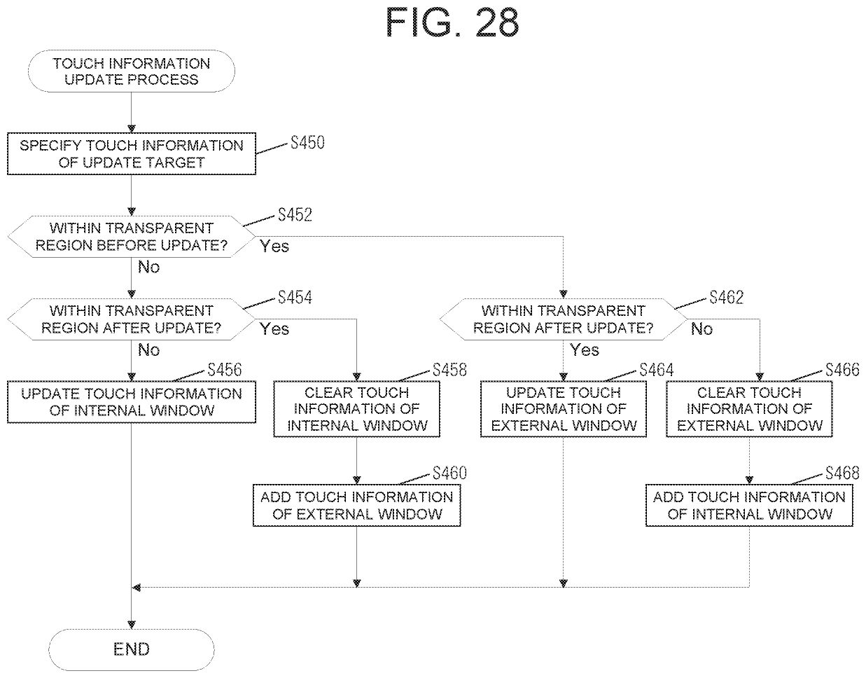

Next, a flow of the touch information update process will be described below with reference to FIG. 28. First, the internal window engine 106 specifies touch information to be updated among touch information stored in the internal window touch information management table 176 or the external window touch information management table 178 (step S450). Subsequently, the internal window engine 106 determines whether coordinates before the update stored in the specified touch information are within the transparent region (step S452).

When the coordinates before the update are not included in the transparent region, the internal window engine 106 determines whether coordinates after the update are included in the transparent region (step S452; No→step S454). When the updated coordinates are not included in the transparent region, the internal window engine 106 updates the touch information specified in step S450 based on the touch event transmitted in step S140 (step S454; No→step S456). In this case, the touch position remains unchanged outside the transparent region before and after the touch information is updated, and therefore, the touch information in the internal window is updated.

On the other hand, when it is determined that the updated coordinates are included in the transparent region in step S454, the internal window engine 106 clears the touch information specified in step S450 (the touch information of the internal window) (step S454; Yes→step S458). Furthermore, the internal window engine 106 adds touch information of the external window by a process similar to the process in step S406 of FIG. 27 (step S460). As a result, when a touch position of a touch operation on a region other than the transparent region is moved to the transparent region, the internal window engine 106 determines a touch operation on the transparent region as an operation on the external window.

Furthermore, when it is determined that the coordinates before the update are included in the transparent region in step S452, the internal window engine 106 determines whether coordinates after the update are included in the transparent region (step S452; Yes→step S462). When the updated coordinates are included in the transparent region, the internal window engine 106 updates the touch information specified in step S450 based on the touch event transmitted in step S140 (step S462; Yes→step S464). In this case, the touch position still remains inside the transparent region before and after the touch information is updated, and therefore, the touch information in the external window is updated.

On the other hand, when it is determined that the updated coordinates are not included in the transparent region in step S462, the internal window engine 106 clears the touch information specified in step S450 (the touch information of the external window) (step S462; No→step S466). Furthermore, the internal window engine 106 adds touch information of the internal window by a process similar to the process in step S404 of FIG. 27 (step S468). As a result, when a touched position of a touch operation on the transparent region is moved to a region other than the transparent region, the internal window engine 106 determines a touch operation on the region other than the transparent region as an operation on the internal window.

### 4.3 Operation Example

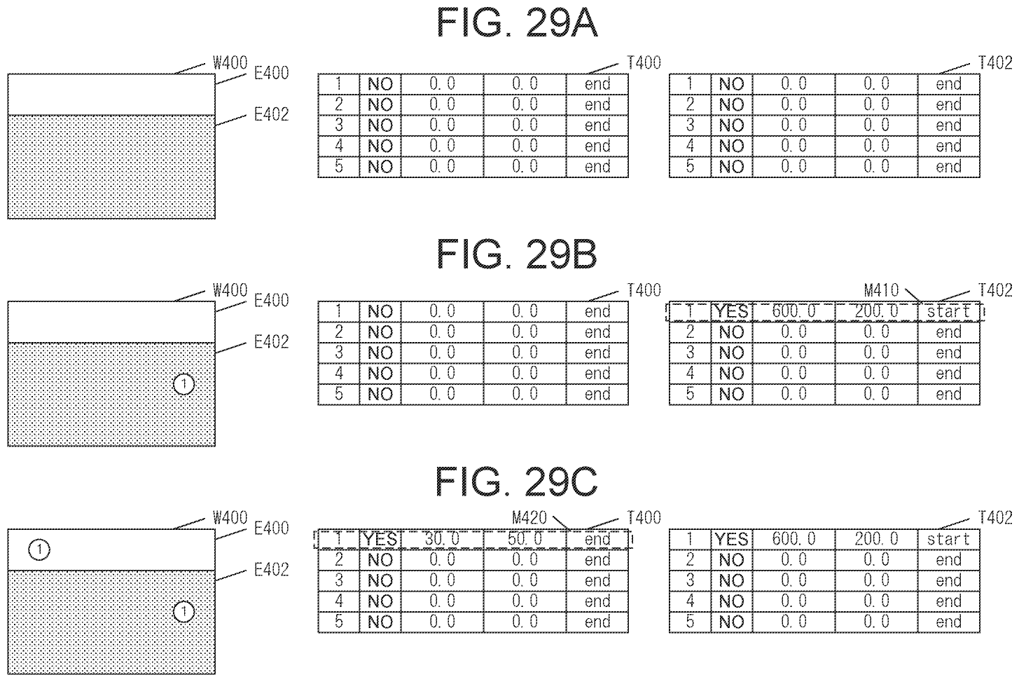

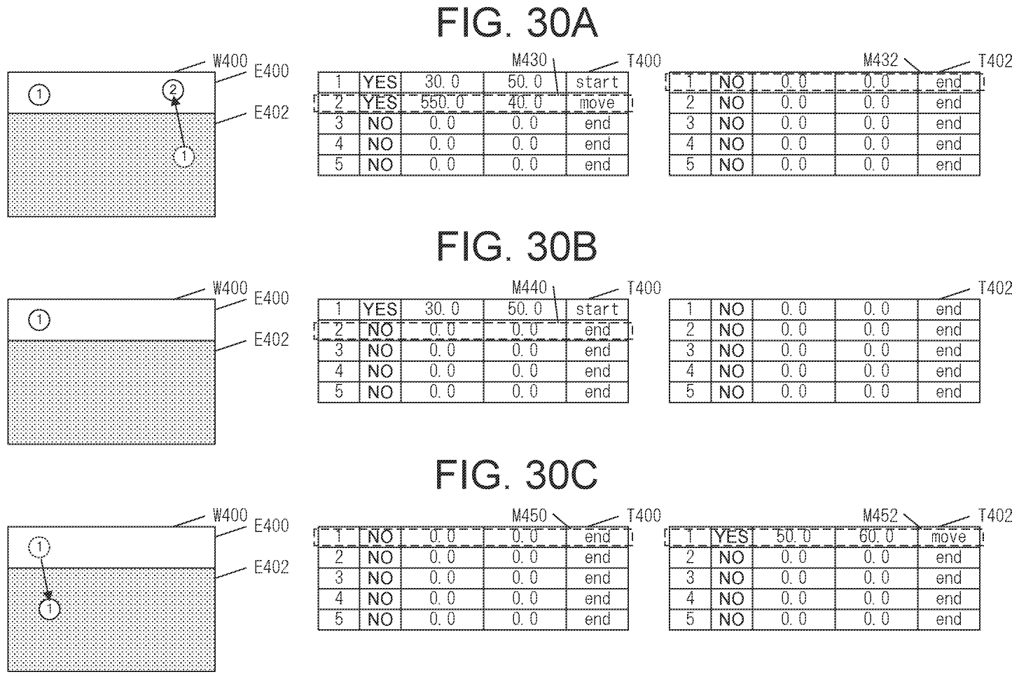

Referring to FIGS. 29A to 29C and FIGS. 30A to 30C, an operation example according to this embodiment will be described. FIGS. 29A to 29C and FIGS. 30A to 30C are diagrams illustrating a display screen W400 including a region E400 displaying the internal window and a region E402 displaying the external window (the transparent region in the internal window), content T400 stored in the internal window touch information management table 176, and content T402 stored in the external window touch information management table 178. Note that each of the content T400 and content T402 includes, from left to right, a touch number, a touch presence/absence, an X coordinate, a Y coordinate, and an action, and numbers included in the display screen W400 correspond to the touch numbers of touch information stored in the corresponding internal or external region touch information management table.

FIG. 29A is a diagram illustrating a case where a touch operation is not performed. When no touch operation is performed, touch information stored in the internal window touch information management table 176 and the external window touch information management table 178 is cleared.

FIG. 29B is a diagram illustrating a case where a touch operation at a first point is performed on the external window. As illustrated in the content T402 in FIG. 29B, first point touch information is added as touch information having a touch number of 1 to the external window touch information management table 178 (M410).

FIG. 29C is a diagram illustrating a case where a touch operation at a second point is newly performed on the internal window while the touch operation at the first point is being performed. As illustrated in the content T400 in FIG. 29C, second point touch information is added as touch information having a touch number of 1 to the internal window touch information management table 176 (M420).

FIG. 30A is a diagram illustrating a case where a touch position of a touch operation managed as touch information having the touch number of 1 in the external window touch information management table 178 is moved (dragged) to the internal window. When touch operations are performed on the external window and then the internal window, it is determined that the touch operation on the external window has been terminated, and corresponding touch information is cleared in the external window touch information management table 178 (M432) and added to the internal window touch information management table 176 (M430). Note that, in FIG. 30A, since touch information having a touch number of 2 has been cleared in the internal window touch information management table 176, touch information of the touch operation corresponding to the touch position moved to the internal window is managed as second touch information of the internal window. Consequently, a process is performed while it is determined that the touch operation at the second point is started in the internal window.

FIG. 30B is a diagram illustrating a case where the touch operation corresponding to the touch information having the touch number of 2 in the internal window touch information management table 176 is terminated. In this case, the corresponding touch information is cleared i the internal window touch information management table 176 (M440).

FIG. 30C is a diagram illustrating a case where the touch position of the touch operation managed as the touch information having the touch number of 1 in the internal window touch information management table 176 is moved (dragged) to the external window. In this case, the corresponding touch information is cleared in the internal window touch information management table 176 (M450) and added to the external window touch information management table 178.

Note that the internal window engine 106 processes the touch operation based on the touch information stored in the internal window touch information management table 176. Furthermore, the internal window engine 106 notifies the browser controller 110 of the touch information stored in the external window touch information management table 178. The touch information is notified from the browser controller 110 to the external window engine 108 via the display controller 104, and therefore, the external window engine 108 processes the touch operation based on the notified touch information.

In this way, when touch operations are performed across windows, the image-forming apparatus of this embodiment can process each of the touch operations as an operation on a window where a touched position is located.

### 5. Modifications

The present disclosure is not limited to the above embodiments, and various changes may be made. Specifically, the technical scope of the present disclosure also includes embodiments obtained by combining technical measures that are modified as appropriate without departing from the scope of the present disclosure. For example, it is possible to extend the foregoing embodiments to allow two or more windows to be displayed, and to control a security layer for each window in detail. In this case, the number of windows may be set to 3 and a native GUI may be displayed in a third window.

Although the foregoing embodiments have been described separately for convenience of explanation, it is apparent that the embodiments are implemented in combination within the technically possible range. For example, the second embodiment and the third embodiment may be combined. In this case, the image-forming apparatus can display a native GUI, and in addition, appropriately process a multi-touch operation.

The program operating in each apparatus according to the embodiment is a program that controls the CPU, and the like (a program that causes the computer to function) so as to perform the functions according to the above-described embodiments. The information handled by these apparatuses is temporarily stored in a temporary storage device (e.g., RAM) during its processing, and then stored in various storage devices, such as a ROM (read only memory) or an HDD, and is read, modified, and written by the CPU as needed.

Here, recording media that store the program may be any of semiconductor media (e.g., ROMs and non-volatile memory cards), optical recording media and magneto-optical recording media (e.g., a DVD (Digital Versatile Disc), an MO (Magneto Optical Disc), an MD (Mini Disc), a CD (Compact Disc), a BD (Blu-ray (registered trademark) Disc) and the like), magnetic recording media (e.g., magnetic tapes and flexible disks), etc. The function according to the above embodiment may be performed by executing the loaded program, and also the function according to the present disclosure may be performed by processing in conjunction with the operating system or other application programs, or the like, based on an instruction of the program.

For distribution in the market, the program may be stored and distributed in a portable recording medium or transferred to a server computer connected via a network such as the Internet, In this case, it is obvious that the present disclosure also includes a storage device of the server computer.

What is claimed is:

1. A display apparatus, comprising:
a display; and
a controller, wherein
the controller
displays, on the display, a first display screen that includes a transparent region and a second display screen displayed behind the first display screen in a superimposed manner, and
processes an operation on the transparent region as an operation on the second display screen and processes an operation on a region other than the transparent region as an operation on the first display screen.

2. The display apparatus according to claim 1, wherein the controller displays, on the first display screen, an input object for performing an input operation on content displayed on the second display screen based on an operation on the second display screen.

3. The display apparatus according to clam 2, wherein the input object is a software keyboard or a dialog.

4. The display apparatus according to claim 1, wherein, in a case where a first touch operation is performed on the transparent region and thereafter a second touch operation is performed before the first touch operation is terminated, the controller processes the second touch operation and a touch operation input in chain to the second touch operation as operations on the second display screen.

5. The display apparatus according to claim 1, wherein, when a touch position on a region other than the transparent region is moved to the transparent region, the controller processes a touch operation on the transparent region as an operation on the second display screen.

6. A method for controlling a display apparatus, the method comprising:
displaying a first display screen that includes a transparent region and a second display screen displayed behind the first display screen in a superimposed manner, and
processing an operation on the transparent region as an operation on the second display screen and processing an operation on a region other than the transparent region as an operation on the first display screen.
